(19) United States
(12) Patent Application Publication
(10) Pub. No.: US 2026/0322845 A1
(43) Pub. Date: Oct. 15, 2026

(54) SYSTEMS AND METHODS FOR MODELING VULNERABILITY AND ATTACKABILITY

(71) Applicant: Ohio State Innovation Foundation, Columbus, OH (US)

(72) Inventors: Vishnu RENGANATHAN, Columbus, OH (US); Qadeer AHMED, Plain City, OH (US)

(21) Appl. No.: 19/113,726

(22) PCT Filed: Sep. 20, 2023
(86) PCT No.: PCT/US2023/033278

§ 371 Date: Mar. 20, 2025

Related U.S. Application Data
(60) Provisional application No. 63/408,164, filed on Sep. 20, 2022.

(51) Int. Cl. H04L 9/40; B60W 30/12; B60W 50/023

(52) U.S. Cl. CPC H04L 63/1433; H04L 63/1416; B60W 30/12; B60W 50/023

(57) ABSTRACT

An example method for performing vulnerability analysis includes providing a system model of a vehicular control system; determining a plurality of attack vectors based on the system model; generating an attacker model based on the plurality of attack vectors; determining a number of vulnerabilities in the system based on at least the attacker model and the system model; and outputting an attackability index based on the number of vulnerabilities.

### CROSS-REFERENCE TO RELATED APPLICATIONS

This application claims the benefit of U.S. provisional patent application No. 63/408,164, filed on Sep. 20, 2022, and titled “VULNERABILITY AND ATTACKABILITY ANALYSIS OF AUTOMOTIVE CONTROLLERS USING STRUCTURAL MODEL OF THE SYSTEM”, the disclosure of which is expressly incorporated herein by reference in its entirety.

### BACKGROUND

Mechanical systems often include combinations of sensors and actuators that are used to control the mechanical system. Data from sensors is used by both human operators, and computerized control systems, to make decisions about how to control the system. Actuators are used to control mechanical parts of the system, for example by opening and closing valves or manipulating mechanical linkages. The actuators can be controlled by the human operators, or by the computerized control system, or combinations of both.

These mechanical systems are vulnerable to attack and failure. When a sensor fails, incorrect data can be recorded, causing control systems to behave incorrectly. Likewise, when a sensor is attacked (for example by a hacker or other malicious user), the sensor may deliberately transmit incorrect data. Actuators provide another vulnerability to mechanical systems. Again, the failure of an actuator can result in incorrect control outputs, or loss of control. Likewise, an attack (again, for example, by a hacker) can cause the actuator to perform undesired control outputs.

Improved methods of designing and analyzing attacks on systems can improve the safety of those systems.

### SUMMARY

In some aspects, the techniques described herein relate to a method for performing vulnerability analysis, the method including: providing a system model of a vehicular control system; determining a plurality of attack vectors based on the system model; generating an attacker model based on the plurality of attack vectors; determining a number of vulnerabilities in the vehicular control system based on at least the attacker model and the system model; outputting an attackability index based on the number of vulnerabilities.

In some aspects, the techniques described herein relate to a method, wherein the plurality of attack vectors include a plurality of unprotected measurements.

In some aspects, the techniques described herein relate to a method, wherein at least one of the plurality of unprotected measurements is associated with a sensor.

In some aspects, the techniques described herein relate to a method, wherein at least one of the plurality of unprotected measurements is associated with an actuator.

In some aspects, the techniques described herein relate to a method, further including recommending a design criteria to protect a measurement from the plurality of unprotected measurements based on the attackability index.

In some aspects, the techniques described herein relate to a method, wherein the design criteria includes a location in the vehicular control system to place a redundant sensor, a redundant actuator, a protected sensor, or a protected actuator.

In some aspects, the techniques described herein relate to a method, further including providing, based on the attackability index, the vehicular control system, wherein a measurement from the plurality of unprotected measurements is protected in the vehicular control system.

In some aspects, the techniques described herein relate to a method, wherein the vehicular control system includes a Lane Keep Assist System.

In some aspects, the techniques described herein relate to a method, wherein the vehicular control system includes an actuator.

In some aspects, the techniques described herein relate to a method, wherein the vehicular control system further includes a communication network.

In some aspects, the techniques described herein relate to a method, further including evaluating the attackability index using a model-in-loop simulation.

In some aspects, the techniques described herein relate to a method of reducing an attackability index of a vehicular control system, the method including: providing a system model of the vehicular control system, wherein the system model includes a plurality of sensors; determining a plurality of attack vectors based on the system model; generating an attacker model based on the plurality of attack vectors; determining a number of vulnerabilities in the vehicular control system based on at least the attacker model and the system model; outputting an attackability index based on the number of vulnerabilities; and selecting a sensor from the plurality of sensors to protect to minimize the attackability index.

In some aspects, the techniques described herein relate to a method, wherein the vehicular control system includes a Lane Keep Assist System.

In some aspects, the techniques described herein relate to a method or claim 12, wherein the vehicular control system includes an actuator.

In some aspects, the techniques described herein relate to a method, wherein the vehicular control system further includes a communication network.

In some aspects, the techniques described herein relate to a method, further including generating a residual based on the system model.

In some aspects, the techniques described herein relate to a method, further including determining where in the system model to place a redundant sensor.

In some aspects, the techniques described herein relate to a method, further including identifying a subset of redundant sensors in the plurality of sensors.

In some aspects, the techniques described herein relate to a method, further including evaluating the attackability index using a model-in-loop simulation of the system model and the attacker model.

In some aspects, the techniques described herein relate to a method, further including identifying a redundant section of the system model and a non-redundant section of the system model.

In some aspects, the techniques described herein relate to a method, further including mapping the plurality of attack vectors to the redundant section of the system model and the non-redundant section of the system model.

It should be understood that the above-described subject matter may also be implemented as a computer-controlled apparatus, a computer process, a computing system, or an article of manufacture, such as a computer-readable storage medium.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 illustrates an example method for performing vulnerability analysis, according to implementations of the present disclosure.

FIG. 2 illustrates a method of reducing an attackability index of a vehicle system, according to implementations of the present disclosure.

FIG. 3 illustrates an example system model, including a vehicular control system architecture, according to implementations of the present disclosure.

FIG. 4 illustrates an example computing device.

FIG. 5 illustrates Dulmage-Mendelsohn's decomposition of a structural matrix, according to implementations of the present disclosure.

FIG. 6 illustrates a control structure of a lane keep assist system, according to implementations of the present disclosure.

FIG. 7 illustrates structural matrices and DMD of a lane keep assist system for three simulated cars, according to implementations of the present disclosure.

FIG. 8 illustrates states an variables of an example lane keep assist system, according to implementations of the present disclosure.

FIG. 9 illustrates an example control structure for an example lane keep assist system, according to implementations of the present disclosure.

FIG. 10A illustrates an example structural matrix from a study of an example implementation of the present disclosure.

FIG. 10B illustrates an example Dulmage-Mendelsohn's Decomposition of a Lane keep assist system, according to an implementation of the present disclosure.

FIG. 11 illustrates an attack signature matrix for a study of an example implementation of the present disclosure.

FIG. 12A illustrates a matching step, according to implementations of the present disclosure.

FIG. 12B illustrates a Hasse diagram, according to implementations of the present disclosure.

FIG. 12C illustrates a computational sequence for TES-1 (R₁), matching (sensor placement strategy), according to implementations o the present disclosure.

FIG. 13 illustrates an example of all possible matching for TES-1, according to implementations of the present disclosure.

FIG. 14A illustrates a matching step, according to implementations of the present disclosure.

FIG. 14B illustrates a Hasse diagram, according to implementations of the present disclosure.

FIG. 14C illustrates a computational sequence for TES-1 (RD, matching (sensor placement strategy), according to implementations of the present disclosure.

FIG. 15A illustrates Chi-squared detection of residual R₁ under normal unattacked operation, according to implementations of the present disclosure.

FIG. 15B illustrates Chi-squared detection of residual R₁ under naive attack A₆ and A₇.

FIG. 15C illustrates Chi-squared detection of residual R₁ under stealthy attack A₆ and A₇.

FIG. 16 illustrates the vehicle deviation from the lane in the simulated environment under attack, according to implementations of the present disclosure.

FIG. 17A illustrates Chi-squared detection of residual R1 under attack A1 according to implementations of the present disclosure.

FIG. 17B illustrates protected residual R1 under normal unattacked operation, according to implementations of the present disclosure.

FIG. 17C illustrates protected residual R1 under stealthy attack A6 and A7, according to implementations of the present disclosure.

FIG. 18A illustrates Cumulative SUM (CuSUM) detection of residual R1 under stealthy attacks A6 and A7, according to implementations of the present disclosure.

FIG. 18B illustrates CuSUM detection of protected residual R1 under normal unattacked operation, according to implementations of the present disclosure.

FIG. 18C illustrates CuSUM detection of protected residual R1 under stealthy attack A6 and A7, according to implementations of the present disclosure.

FIG. 19 illustrates a table of example variable parameters for a lane keep assist system, according to implementations of the present disclosure.

FIG. 20 illustrates an attack signature matrix and computation sequence for residue R_1 (TES-1).

FIG. 21A illustrates Residual R₁ threshold detection under normal unattacked operation, according to implementations of the present disclosure.

FIG. 21B illustrates Residual R₁ threshold detection under attacks A₉ and A₁₀, according to implementations of the present disclosure.

FIG. 21C illustrates Residual R₁ threshold detection under attack A₁, according to implementations of the present disclosure.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where said feature, event or circumstance occurs and instances where it does not. Ranges may be expressed herein as from “about” one particular value, and/or to “about” another particular value. When such a range is expressed, an aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. While implementations will be described for resolving ambiguities in text, it will become evident to those skilled in the art that the implementations are not limited thereto, but are applicable for generative artificial intelligence systems and methods.

As used herein, the terms “about” or “approximately” when referring to a measurable value such as an amount, a percentage, and the like, is meant to encompass variations of ±20%, ±10%, ±5%, or ±1% from the measurable value.

Modeling security of complex systems is computationally challenging due to the large number of inputs and outputs those systems can include, and the way those inputs and outputs can be correlated with each other. These challenges can be increased by the presence of communications and control systems that take the inputs (e.g., sensor data) and generate outputs (e.g., control signals for actuators) based on complicated logic. Complex systems are vulnerable to attacks (e.g., malicious interference, or “hacking”) where real communications signals are disrupted, or fake communication signals are inserted into the system. Detecting attacks can be possible by looking at the state of the system as a whole to identify a specific part of the system that is being attacked (e.g., a subset of the actuators and/or sensors). However, techniques to detect attacks can depend on having some sensors that are protected from attack, and/or having redundant sensors. Designers of complex systems (for example, vehicles including automated driving features), can benefit from systems and methods that evaluate a complex system (like a modern car) and determine how vulnerable to attack that vehicle is (e.g., an “attackability index”). Designers can further benefit by systems and methods that determine how to improve that attackability index for a given design. The systems and methods described herein can evaluate complicated systems to generate attackability indexes using attack vectors, and simulate those attacks to validate the attackability index of a system. The systems and methods described herein can provide design recommendations for the system based on attackability index. For example, the systems and methods described herein can determine where to place redundant and/or protected sensors to improve the attackability index of a system. Further, the methods described herein can include providing the system with one or more redundant and/or protected sensors.

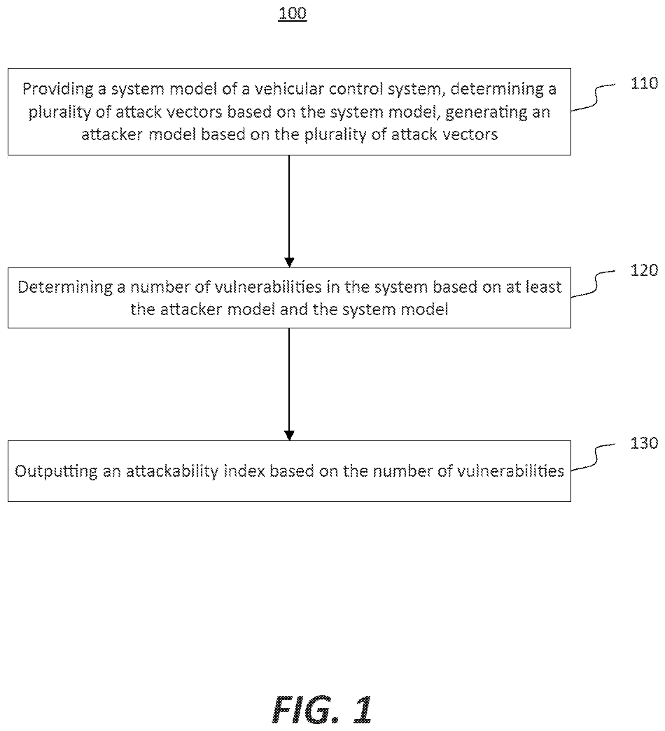

With reference to FIG. 1, a method 100 for performing vulnerability analysis is shown.

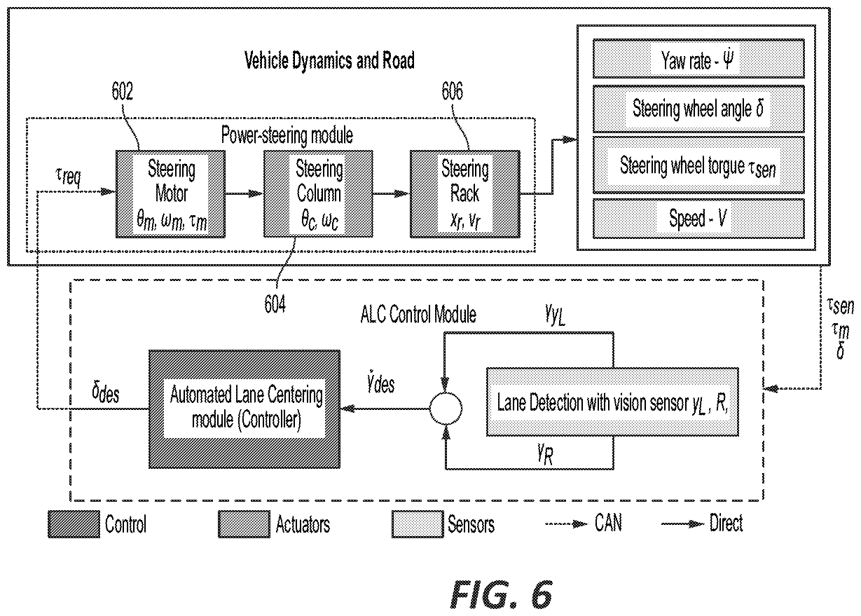

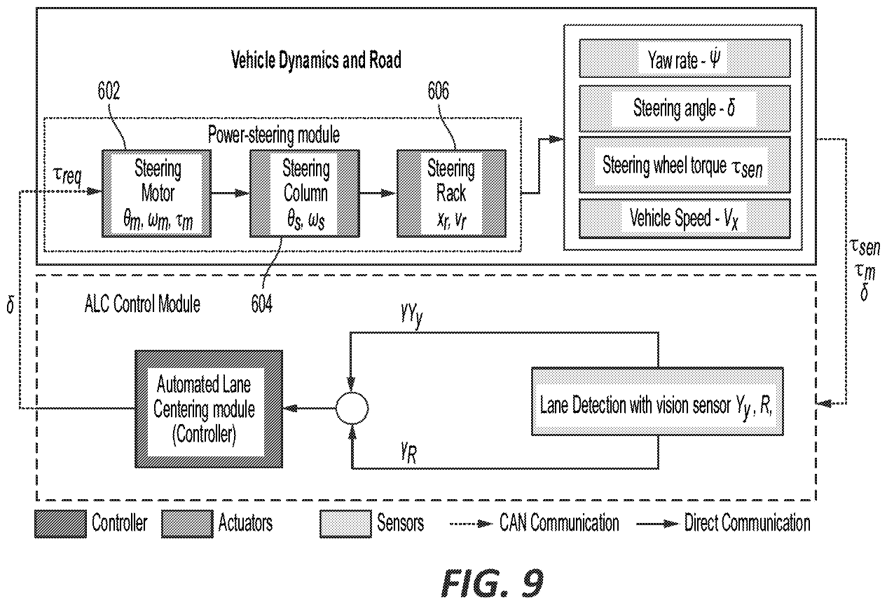

At step 110, the method includes providing a system model of a vehicular control system. Example system models of vehicular control systems are described in Examples 1, 2, and 3, for example with reference to FIGS. 6 and 9. In Examples 1, 2, and 3, the vehicular control system is a Lane Keep Assist System, but it should be understood that any vehicular control system can be used in implementations of the present disclosure.

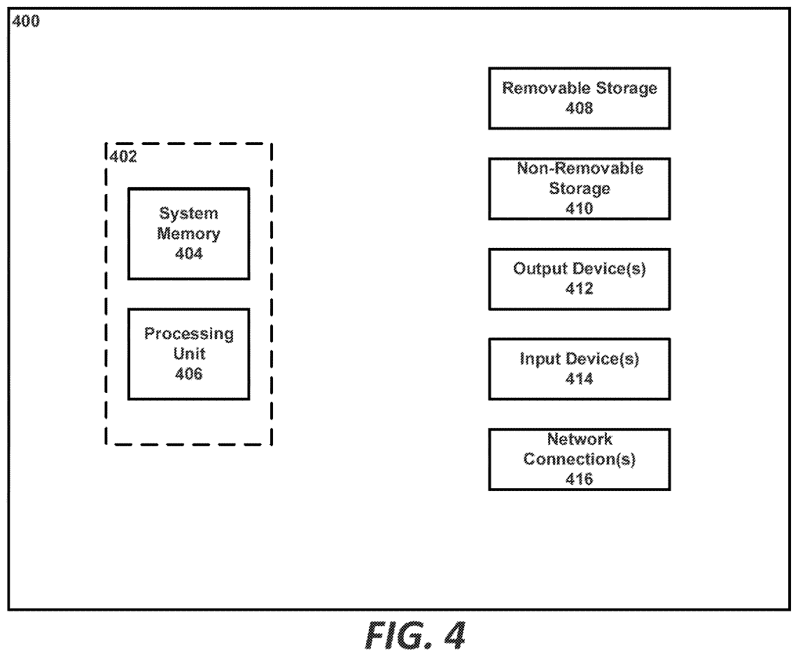

In some implementations, the vehicular control system can include an actuator and/or a communication network. One or more operations of the vehicular control system can optionally be implemented using one or more computing devices 400, illustrated in FIG. 4. The actuator can optionally be a steering motor 602, steering column 604, or steering rack 606 as illustrated in FIGS. 6 and 9. This disclosure contemplates that the communication network is any suitable communication network. Example communication networks can include a local area network (LAN), a wireless local area network (WLAN), a wide area network (WAN), a metropolitan area network (MAN), a virtual private network (VPN), etc., including portions or combinations of any of the above networks. Optionally, as described herein, the communication network is a controller area network.

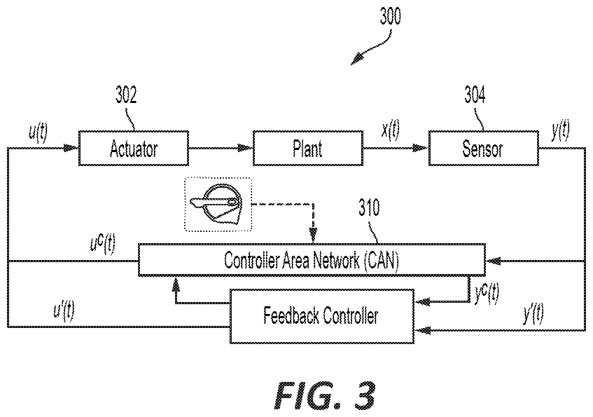

A block diagram of a vehicular control system architecture 300 is illustrated in FIG. 3. The vehicular control system architecture 300 illustrates an actuator 302, a sensor 304, and a controller area network 310. Optionally, the communication network included in the vehicular control system described with reference to step 110 of FIG. 1 can be a controller area network 310.

Referring again to FIG. 1, at step 120, the method includes determining a plurality of attack vectors based on the system model. In some implementations, the plurality of attack vectors include a plurality of unprotected measurements. Optionally, the unprotected measurements are associated with one or more sensors. Such sensors may be compromised in an attack. Alternatively or additionally, the unprotected measurements are associated with one or more actuators. Such actuators may be compromised in an attack. It should be understood that the step 120 can include any number of actuators and/or sensors.

As used herein, the term “protected measurement” refers to a measurement associated with a sensor or actuator that cannot be attacked (e.g. intentionally hacked or sabotaged), and the term “unprotected measurement” refers to a measurement associated with a sensor or actuator that can be attacked (e.g., intentionally hacked or sabotaged). Additional description of unprotected and protected measurements, and types of attacks that can be performed on unprotected measurements, are provided in examples 1, 2, and 3.

At step 130, the method 100 includes outputting an attackability index based on the number of vulnerabilities. The attackability index can optionally be based on the number of vulnerabilities in the system. The number of vulnerabilities in the system can be proportional to the number of sensors and/or actuators that can be compromised (i.e., unprotected actuators and/or sensors). In turn, the number of vulnerabilities in the system can be proportional to the number of unprotected measurements in the system. Details of example calculations of attackability index are described with reference to examples 1, 2, and 3 herein.

In some implementations, the method 100 can further include recommending a design criteria to protect a measurement from the plurality of unprotected measurements based on the attackability index. The design criteria can include, but is not limited to, a location in the vehicular control system to place a redundant sensor, a location in the vehicular control system to place a redundant actuator, a location in the vehicular control system to place a protected sensor (e.g., a hard-wired sensor), or a location in the vehicular control system to place a protected actuator (e.g., a hard-wired actuator). This disclosure contemplates that such location, sensor, and/or actuator can be identified using the system model.

In some implementations, the method optionally further includes providing the vehicular control system, where the vehicular control system is designed to protect one or more measurements. As described herein, such design can be determined using method 100, for example, by identifying a location, sensor, and/or actuator vulnerable to attack and thus placing a redundant or protected (e.g., hard-wired component) in its place. In other words, the vehicular control system design is determined, at least in part, using the attackability index output at step 130.

In some implementations, the method can further include evaluating the attackability index output at step 130 using a model-in-loop simulation. As used herein, a model-in-loop simulation refers to a simulation using the model based on sample data. The sample data used herein can include data that simulates an attack.

In some implementations, the method can further include determining a location to place a sensor in the system to make the system less attackable (i.e., improve the attackability index). As described herein with reference to Examples 1, 2, and 3, redundant sensors can reduce attackability of systems by making it easier to detect attacks on the other sensors in the system.

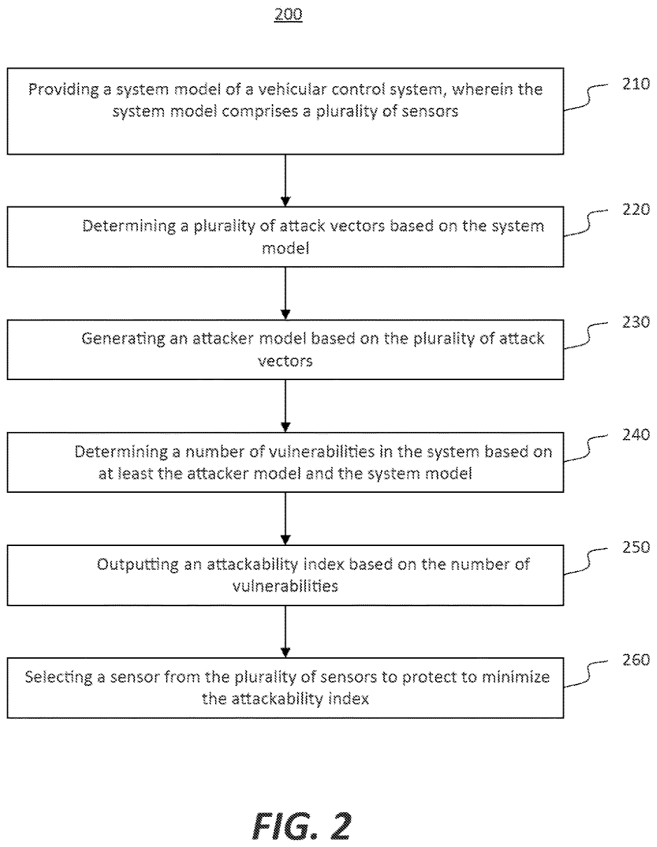

With reference to FIG. 2, a method 200 for reducing an attackability index of a vehicle system is shown.

At step 210, the method 200 includes providing a system model of a vehicular control system. Details of the system model are described with reference to FIGS. 1 and 3 herein.

At step 220 the method 200 includes determining a plurality of attack vectors based on the system model.

At step 230 the method 200 includes generating an attacker model based on the plurality of attack vectors.

At step 240 the method 200 includes determining a number of vulnerabilities in the system based on at least the attacker model and the system model.

At step 250 the method 200 includes outputting an attackability index based on the number of vulnerabilities.

At step 260, the method 200 includes selecting a sensor from the plurality of sensors to protect to minimize the attackability index. In some implementations, the sensor can be selected based on redundancies in the system, and the redundancies in the system can optionally be determined by generating a residual based on the system model of the system. In some implementations of the present disclosure, residuals can be used to determine a subset of redundant sensors of the plurality of sensors.

Alternatively or additionally, the method can further include determining where to place one or more redundant sensors in the system.

In some implementations, the method can further include performing model-in-loop simulations of the system model and the attacker model. The model-in-loop simulations can optionally be used to evaluate the accuracy of the attackability index by simulating an attack. Additional details of the model-in-loop simulations for an example vehicular control system are described with reference to examples 1, 2, and 3.

In some implementations, the method can further include identifying a redundant section of the system model and a non-redundant section of the system model. Identifying the non-redundant section or sections of the system model can be used to determine vulnerabilities to attack. Alternatively or additionally, identifying non-redundant sections of the system model can be used to determine where to place protected and/or redundant sensors and/or actuators to reduce the attackability of the system.

Optionally, the method can further include mapping the plurality of attack vectors to the redundant and non-redundant sections of the system model. Additional examples and details of mapping attacks to redundant and non-redundant sections of the system model are described in Example 2, below.

It should be appreciated that the logical operations described herein with respect to the various figures may be implemented (1) as a sequence of computer implemented acts or program modules (i.e., software) running on a computing device (e.g., the computing device described in FIG. 4), (2) as interconnected machine logic circuits or circuit modules (i.e., hardware) within the computing device and/or (3) a combination of software and hardware of the computing device. Thus, the logical operations discussed herein are not limited to any specific combination of hardware and software. The implementation is a matter of choice dependent on the performance and other requirements of the computing device. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

Referring to FIG. 4, an example computing device 400 upon which the methods described herein may be implemented is illustrated. It should be understood that the example computing device 400 is only one example of a suitable computing environment upon which the methods described herein may be implemented. Optionally, the computing device 400 can be a well-known computing system including, but not limited to, personal computers, servers, handheld or laptop devices, multiprocessor systems, microprocessor-based systems, network personal computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

In its most basic configuration, computing device 400 typically includes at least one processing unit 406 and system memory 404. Depending on the exact configuration and type of computing device, system memory 404 may be volatile (such as random access memory (RAM)), non-volatile (such as read-only memory (ROM), flash memory, etc.), or some combination of the two. This most basic configuration is illustrated in FIG. 4 by dashed line 402. The processing unit 406 may be a standard programmable processor that performs arithmetic and logic operations necessary for operation of the computing device 400. The computing device 400 may also include a bus or other communication mechanism for communicating information among various components of the computing device 400.

Computing device 400 may have additional features/functionality. For example, computing device 400 may include additional storage such as removable storage 408 and non-removable storage 410 including, but not limited to, magnetic or optical disks or tapes. Computing device 400 may also contain network connection(s) 416 that allow the device to communicate with other devices. Computing device 400 may also have input device(s) 414 such as a keyboard, mouse, touch screen, etc. Output device(s) 412 such as a display, speakers, printer, etc. may also be included. The additional devices may be connected to the bus in order to facilitate communication of data among the components of the computing device 400. All these devices are well known in the art and need not be discussed at length here.

The processing unit 406 may be configured to execute program code encoded in tangible, computer-readable media. Tangible, computer-readable media refers to any media that is capable of providing data that causes the computing device 400 (i.e., a machine) to operate in a particular fashion. Various computer-readable media may be utilized to provide instructions to the processing unit 406 for execution. Example tangible, computer-readable media may include, but is not limited to, volatile media, non-volatile media, removable media and non-removable media implemented in any method or technology for storage of information such as computer readable instructions, data structures, program modules or other data. System memory 404, removable storage 408, and non-removable storage 410 are all examples of tangible, computer storage media. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 406 may execute program code stored in the system memory 404. For example, the bus may carry data to the system memory 404, from which the processing unit 406 receives and executes instructions. The data received by the system memory 404 may optionally be stored on the removable storage 408 or the non-removable storage 410 before or after execution by the processing unit 406.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the disclosure.

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

### Example 1

A study was performed of an example implementation of the present disclosure configured to quantify security of systems. A security index of a system can be derived based on the number vulnerabilities in the system and the impact of attacks that were exploited due to the vulnerabilities. This study comprehensively defines a system model and then identify vulnerabilities that could potentially be exploited into attacks. The example implementation can quantify the security of the system by deriving attackability conditions of each nodes in the system.

The concept of fault can be different from attacks. As used in the present example, abnormal behavior in the system is called a fault. Unlike attacks, faults can be arbitrary and can arise either due to malfunction in the system, sensors, actuators or when the controller is not able to achieve its optimal control goal. The theory of Fault-Tolerant-Control (FTC) [1] and Fault Diagnosis and Isolability (FDI) [2] can be used to detect and identify faults using structural models of the system. These theories of fault-tolerant control can perform canonical decomposition to determine redundancies in the system. Residuals calculated from these redundancies are used to detect and isolate faults. On the other hand, attacks can be specifically targeted to exploit the vulnerabilities in the system that can arise due to improper network segmentation (improper gateway implementation in CAN), open network components (OBD-II) or sensors exposed to external environments (GPS, camera). Thus, based on how vulnerable a measurement is, the present disclosure can categorize them as protected and unprotected measurement. The unprotected measurements are attackable and an overall attack index is derived based on complexity of successful attack. The term “successful attack” as used herein can refer to stealthy attacks that are not detected in the system [3]. A failed attack can be shown in the system as an abnormality or fault.

The complexity of attacking a measurement in the system is determined based on how redundant the measurement is in the system and if the redundant measurement is used to calculate residues to detect abnormalities in the system. For example, as shown in [4] an observable system with Extended Kalman Filter (EKF) and an anomaly detector is still attackable and the sensor attack can be stealthy as long as the deviation in the system states due to the injected falsified measurement is within the threshold bounds. This type of additive attacks can eventually drive the system to unsafe attacked state while still remaining stealthy. However, the attack proposed is complex in time and computation as multiple trial-and-error attempts are required to learn an attack signal that is stealthy. Also, stealthy execution of the attack can become very complex due to the dynamic nature of driving patterns.

As described herein, an unprotected measurement is attackable and implementations of the present disclosure can determine an attackability score based on on the complexity in performing the attack. For example, systems that use anomaly detectors based on EKF are attackable, but it can be time and consuming and computationally demanding to identify those attack signals that stay within the anomaly detector's residual threshold. Also, the attack fails if the system uses a more complex anomaly detector like CUmulative SUM (CUSUM) or Multivariate Exponentially Weighted Moving Average (MEWMA) detectors instead of the standard Chi-Squared detectors. The complexity of performing the attack also depends on redundancies in the system and their efficient usage to calculate residues for anomaly detection. Apart from observer-based techniques, the anomaly detectors can also be designed based on the redundancies in the system and still involve the tedious procedure to identify the precise set of attack vectors to perform a stealthy undetectable attack.

The example implementation of the present disclosure studied includes a system model, attacker model, a way of structurally defining the system, and deriving an attackability index based on the defined structure. The example implementation includes an example model of vehicular systems as shown in FIG. 3. The network layer that is used to transmit sensor messages to the actuator is CAN. The attacker can attack the system either by injecting attack signals by compromising the CAN or by performing adversarial attacks on the sensors.

Implementations of the present disclosure include a System Model, for example, a structured Linear Time-Invariant (LTI) system:

\dot{x}(t)=Ax(t)+Bu(t)

y(t)=Cx(t) (1)

where x(t)∈ [symbol] ⁿ is the state vector, u(t)∈ [symbol] ^{q} is the control input and y(t)∈ [symbol] ^{m} are the sensor measurements. A∈ [symbol] ^{n×n}, B∈ [symbol] ^{n×q} and C∈ [symbol] ^{m×n} are the system, input, and output matrices respectively.

Implementations of the present disclosure include an Attacker model

The example implementation includes an attacker model defined by:

\dot{x}^{c}(t)=Ax(t)+Bu(t)+Bₐaₐ(t)

y^{c}(t)=Cx(t)+Cₐaₛ(t) (2) [5]

where aₐ(t)∈ [symbol] ^{p}^{₁} and aₛ(t)∈ [symbol] ^{p}^{₂} are the actuator and sensor attack vectors p₁+p₂=p. The compromised state of the system at time t can be written as \dot{x}ᵢ^{c}(t)=Σⱼ₌₁ⁿ(A_{i,j}xⱼ(t))+Bu(t)+B_{a,i}a_{a,i}(t). Where uᵢ^{c}(t)=B_{a,i}a_{a,i}(t) is the actuator attack signal injected by the attacker. Similarly, yᵢ^{c}(t)=Cx(t)+C_{a,i}a_{s,i}(t) is a compromised sensor measurement and a_{s,i}(t) in the attack injected. u′(t)∈ [symbol] ^{q-p} and y′(t)∈ [symbol] ^{m-p} are the actuator and sensor signals that have not been compromised due to the attack.

The example implementation includes a structural model of a system. In the structural model of the system, the study analyzed the qualitative properties of the system to identify the analytically redundant part(s) [2]. The non-zero elements of the system realization is called the free parameters and they are of our main interest. Thus, with the free parameters, system's structure can be represented by a bipartite graph G=(V∪E, Γ) where V={x₁, x₂, . . . , xₙ, y₁, y₂, . . . , yₘ, u₁, u₂, . . . , u_{q}, a₁, a₂, . . . , aₚ} are the set of nodes corresponding to the state, output, input, and attack vectors. These set of variables can be further classified into knows Z⊂V and unknowns X⊂V. The bipartite graph is often represented by a weighted graph where the weight of each edge corresponds to [A, B, Bₐ: C, Cₐ]. The relationship of these variables in the system is represented by the set of equations (or constraints) E={e₁, e₂, . . . , eᵣ}. Γ={(eᵢ,vⱼ)|vⱼ in eᵢ,vⱼ∈V, i∈[1, 2, . . . , r], j∈[1, 2, . . . , n+m+q]} is an edge which links the equation eᵢ to variable vⱼ. The matrix form of bipartite graph can be represented as a adjacency matrix M (Structural Matrix), a Boolean matrix with rows corresponding to E and columns to V and M={m_{i,j}|m_{i,j}=1 if (eᵢ, vⱼ)∈Γ, 0 otherwise}. In the above definition, we consider the differentiated variables to be structurally different from integrated variables.

Definition 1: (Matching) Matching on a structural model M is a subset of Γ such that two projections of any edges in M are injective. This indicates that any two edges in G do not share a common node. A matching is maximal if it contains the largest number of edges (maximum cardinality) and perfect if all the vertices are matched. The non-matched equations of the bipartite graph represents the Analytically Redundant Relations (ARR).

The motive of structural analysis can be to identify matchings in the system. If an unknown variable is matched with a constraint, then it can be calculated from the constraint. If they can be matched in multiple ways, they contribute to a redundancy, that can be potentially used for abnormality detection. Based on the redundancy, the system can be divided into three sub-models: under-determined (no. of unknown variables>no. of constraints), just-determined (no. of unknown variables=no. of constraints) and overdetermined part (no. of unknown variables<no. of constraints). An alternate way of representing the adjacency matrix is Dulmage-Mendelsohn's (DM) decomposition [6]. DM decomposition is obtained by rearranging the adjacency matrix in block triangular form and is a better way to visualize the categorized sub-models in the system. The underdetermined part of the model is represented by G⁻ with node sets E⁻ and V⁻ the just-determined or the observable part is represented by G⁰ with node sets E⁰ and V⁰, and the overdetermined part is represented by G⁺ with node sets E⁺ and V⁺. Attack vectors in the under-determined (a⁻) and just determined (a⁰) part of the system are not detectable. While, Attack vectors in the over-determined (a⁺) part of the system is detectable with help of redundancies in the system.

Attackability Index. The example implementation derived the attackability index based on the number of vulnerabilities in the system, which could potentially be exploited into attacks. That is, it is the number of sensors and actuators that can be compromised or the number of unprotected measurements in the system. Thus, larger the attack index, more vulnerable is the system.

Let

$$a = [ \begin{matrix}{a}_{a} \\ {a}_{s}\end{matrix} ] ∈ {\text{?}}^{p}$$

be the attack vector. The attackability index α is proportional to λ=∥a∥₀ and is given by:

$$α = {\sum }_{i = 1}^{p} {W}_{i} - {‖ r ‖}_{0} \qquad ( 3 )$$

Where Wᵢ is the penalty added depending on the attack; based on whether the attack vector is in the under, just or over-determined part and r is the residues in the system for attack/fault detection. The attack becomes stealthy and undetectable if in the under or just-determined part of the system and at the same time, it is easier to perform the attack, hence a larger penalty is added to α. If the attack is in the over-determined part, the complexity of performing a stealthy attack increases drastically due to the presence of redundancies, hence a smaller penalty is added.

The overall security goal of the system can be to minimize the attackability index: minimize α with respect to the attacker model as defined in equation 2 and maximize ∥r∥₀ (the number of residues) when a≠0. This security goal can be achieved in two ways: (i) Replace unprotected measurements with protected measurements. However, this may not be feasible as it requires drastic change in In-Vehicle Network (IVN). [7](ii) Introduce redundancy in the system to detect abnormalities. With redundancy in the system, residues can be generated and a detector can be designed to identify abnormalities. In this way, the system may still be susceptible to attacks but a stealthy implementation of the attack can be very hard as the attacker must compromise multiple measurements. If the attacker fails in performing a stealthy attack, the abnormalities in the measurements introduced by the attacker is shown as faults in the system.

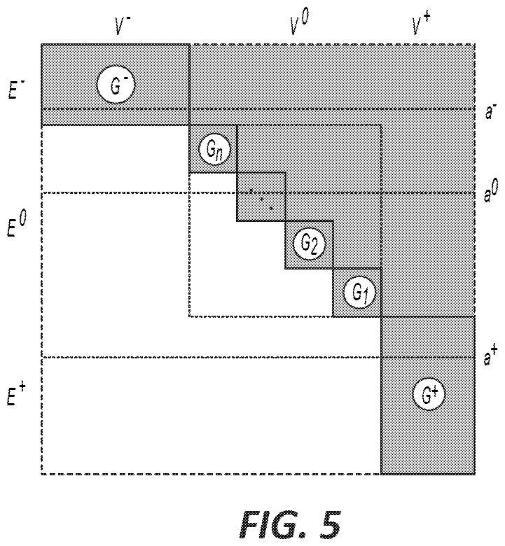

The study analyzed the given system to identify vulnerabilities that could potentially be exploited into attacks. The impact and the complexity of the attacks are derived from the DM decomposition of the system. An example Dulmage-Mendelsohn's Decomposition of a structural matrix is shown in FIG. 5. The attacks that fall on the under and just-determined part of the system are not detectable and hence have severe consequences. Thus, by performing the vulnerability analysis the study answers the following questions:
(1) For a given system, what are the potential vulnerabilities that can be exploited into attacks?
(2) How impactful are the attacks, are the attacks stealthy?
(3) What is complexity in performing the attack. What is the minimum number sensors and actuators that have to be compromised to perform the stealthy attacks?
(4) What is the overall attackability score of the system and what are the optimal solutions to increase the security index of the system?

The system and attacks used in the study are described in equations 1 and 2. From G⁺ part of the DM decomposition, residuals can be generated using the unmatched redundant constraints and can be checked for consistency. The structure of the residue is the set of constraints—monitorable sub-graphs with which they are constructed. The monitorable subgraphs are identified by finding the Minimal Structurally Overdetermined (MSO) set as defined [8].

Definition 2: (Proper Structurally Overdetermined (PSO)) A non-empty set of equations E≠Ø is PSO if E=E⁺.

The PSO set is the testable subsystem, which may contain smaller subsystems—MSO sets.

Definition 3: (Minimal Structurally Overdetermined (MSO)) A PSO set is MSO set if no proper subset is a PSO set.

MSO sets are used to find the minimal testable and monitorable subgraph in a system.

Definition 4: Degree of structural redundancy is given by φ(E)=|E⁺|−|X⁺|

Lemma 1: If E is a PSO set of equations with e∈E, then φ(E\{e})≥φ(E)−1.

Lemma 2: The set of equations E is an MSO set if and only if E is a PSO set and φ(E)=1

The proof Lemma 1 and Lemma 2 is given in [8] by using Euler's totient function definition [9].

For each MSO set identified according to Lemma 2, a set of equation called the Test Equation Support (TES) can be formed which is used to test for faults or attacks. By eliminating unknown variables from the set of equations (parity space-like approaches) a sequential residual can be obtained.

Definition 5: (Residual Generator) A scalar variable r generated only from known variables (z) for the model M is the residual generator. The anomaly detector looks if the scalar value of the residue is within the threshold limits under normal operating conditions. Ideally, it should satisfy lim_{t→∞}r(z)=0.

A set of MSO, might involve multiple sensor measurements and known parameters in the residual generation process. The generated residue is actively monitored using an anomaly detector (for example, the Chi-squared detector).

Definition 6: A system as defined in (1) is not secure (i) If there exists an attack vector that lies in the structurally just-determined part. (ii) If the attack vector aᵢ(t) lies in the over-determined part such that it does not trigger the anomaly detector

$${χ}^{2} = {\overline{{r}_{t}}}^{T} \overline{{r}_{t}} < λ .$$

The consequence of the attack is severe if there is a significant deviation of the state from its normal operating range. Ideally, lim_{t→∞}∥Δx(t)∥=∞ is the unbounded condition for the attack sequence.

The example implementation categorizes the measurements from the system as protected and unprotected measurements. From the definition of the system, the example implementation can determine that not all the actuators and sensors in our system are susceptible to attacks. Thus, the attacker can inject attack signals only to those vulnerable, unprotected sensors and actuators.

Conjecture 1: For automotive systems, only those sensors and actuators connected to the CAN and those sensors whose measurements are completely based on the environment outside the vehicle are vulnerable. The measurements from these devices are unprotected measurements. Other sensors and actuators whose measurements are restricted to the vehicle and communicate directly to and from the controller are categorized as protected measurements.

It should be understood that the example implementation does not make assumptions on the type of attack and does not restrict the attack scope in any manner. [10][11]. The study of the example implementation assumes that the only feasible way of attacking a protected sensor is by hard-wiring the sensor or an actuator, which is outside the scope of the analysis performed in the study.

The example implementation can include deriving an attack index for a given system and we distinguish between faults and attacks. The under-determined part of the system is not attackable as the nodes are not reachable. A vertex is said to be reachable is there exists at least a just-determined subgraph of G that has an invertible edge (eᵢ, xⱼ). For example, an attack index of the scale Wᵢ=1 to 10 is assumed, but it should be understood that any range of values can be used to represent an attack index. 1 represents the stealthy attack vector that is very hard to implement on the system due to presence of residues and anomaly detectors and 10 represents the attack vector that compromises the part of the system without residues and anomaly detectors.

Theorem 1: The just-determined part of the system with unprotected sensors and actuators have a higher attack index (Wᵢ=10).

Proof: The higher attack index is due to the presence of undetectable attack vectors from the sensors and actuators. The attack vector aᵢ is not detectable due to the lack of residues to detect them. E⁰ is not an MSO from Definition 3 and Definition 4 is also not valid. The definition for residual generation (Definition 5) is also not valid for E⁰. Hence any attack on E⁰={eₐ_{ᵢ}} is not detectable.

The over-determined part of the system is attackable but the attacks are detectable from the residues generated from MSOs. To have an undetectable attack, the attack vector should satisfy the condition in Definition 6. Thus, the complexity to perform a successful attack is high, which lead to the Theorem 2.

Theorem 2: The over-determined part of the system with unprotected sensors and actuators are still attackable and have a lower attack index due to the complexity in performing an attack (Wᵢ=1).

Proof: From Conjecture 1, the system is attackable if it has unprotected sensors and actuators. However, in the overdetermined part of the system, the attack is detectable and there exists residues to detect the attack. Hence, in order to perform a stealthy attack, the attacker should satisfy the condition (ii) in Definition 6. Here we show the condition for detectability and existence of residues. Let us first consider the transfer function representation of the general model: y=G(s)u+A(s)a. A fault is detectable if there is a residual generator such that the transfer function from fault to residual is non-zero. [12] [13] Thus using a similar definition for attack, an attack is detectable if Rank [G(s)A(s)]>Rank [G(s)]. This satisfies the condition that there exists a transfer function Q(s) such that residue r=Q(s)[y^{T}u^{T}]^{T}. The residues capable of detecting the attack are selected from the MSOs that satisfy the above criterion.

Theorem 2 shows that unprotected measurements cause vulnerabilities in the system that could lead to attacks. However, these attacks are detectable with residues in the system. Thus, to perform a stealthy attack, the attacker must formulate the attack vector as defined in Definition 6 or else the attack will be shown in the system as faults and alert the user. Hence, in the next step we distinguish between faults and attacks.

The properties of the Attack Index can be used by the example implementation of the present disclosure. Example properties are described herein. Limited system knowledge: The structural matrices are qualitative properties of the system and do not always consider the actual dynamical equations of the system. Thus, the attackability score estimation can be performed with a realization of the system and not necessarily with exact system parameters. In other words, the vulnerability analysis of Lane Keep Assist System (LKAS) shown in section V is generic to most vehicle with minor changes in sensor configuration and network implementation. Hence our comparison of LKAS with other vehicles from different manufacturers is a valid and fair comparison. Following the definition from C.1 [14] and [15], Theorem 4 can be formulated as:

Theorem 4: The attackability score and the overall security index of the system remains the same irrespective of the system realization.

Proof: Let H(s)∈ [symbol] ^{m×q} be a transfer function matrix. Let the generic-rank (g-rank) of the transfer function g rank (H)=K. From definition [16], g-rank (H)=is the maximum matching in the bipartite graph G under all realizations of the system. For a given maximum matching, the bipartite graph G can be decomposed as under (V⁻, E⁻), just (V⁰, E⁰) and over-determined (V⁺, E⁺).

For the under-determined part (|E⁻|>0), the subgraph G-contains at least two maximum matching of order |E⁻| and the sets of initial vertices do not coincide. The rank H_{V}_{^{−}}_{E}_{^{−}}(s)=|E⁻|⇒full row rank.

For the just-determined part (|E⁰|=|V⁰|>0), the subgraph G⁰ contains at least one maximum matching of order |E⁰|=|V⁰|. The rank H_{V}_{⁰}_{E}_{⁰}(s)=|E⁰|=|V⁰|⇒H_{V}_{⁰}_{E}_{⁰} is invertible.

For the over-determined part (|V⁺|>0), the subgraph G⁺ contains at least two maximum matching of order |V⁺| and the sets of initial vertices do not coincide. The rank H_{V}_{⁺}_{E}_{⁺}(s)=|V⁺|⇒full column rank.

The DM decomposition of H is given by:

$$[ \begin{matrix}{H}_{{E}^{-} {V}^{-}} ( s ) & {H}_{{E}^{-} {V}^{0}} ( s ) & {H}_{{E}^{-} {V}^{+}} ( s ) \\ 0 & {H}_{{E}^{0} {V}^{0}} ( s ) & {H}_{{E}^{0} {V}^{+}} ( s ) \\ 0 & 0 & {H}_{{E}^{+} {V}^{+}} ( s )\end{matrix} ]$$

Hence in Theorem 4, it is shown that a DM decomposition can be obtained from a transfer function whose coefficients are unknown (free parameters). Thus, for any choice of free parameters in system realization, the attack index derived through structural analysis is generic. A qualitative property thus holds for all system with same structure and sign pattern. Meaning, the structural analysis is concerned with zero and non-zero elements in the parameters and not their exact values.

Implementations of the present disclosure include vulnerability analysis of lane keep assist systems.

The example implementation includes methods for vulnerability analysis of a system. The study included an analysis of an Automated Lane Centering System (ALC). The example implementation models a Lane Keep Assist System (LKAS), with vehicle dynamics, steering dynamics and the communication network (CAN).

The system model as shown in FIG. 6 uses an LKA controller, (typically a Model Predictive Controller (MPC) [17] or Proportional-Integral-Derivative (PID) controller [18]) to actuate a DC motor connected to the steering column to steer the vehicle to the lane center. The LKAS module has three subsystems: (i) the steering system—steering column [e1-e4], steering rack [e8-e10], (ii) the power assist system [e5-e7] and (iii) the vehicle's lateral dynamics control system [e11e16]. The LKAS is implemented on an Electronic Control Unit (ECU) with a set of sensors to measure the steering torque, steering angle, vehicle lateral deviation, lateral acceleration, yaw rate and vehicle speed. The general mechanical arrangement of LKAS and the dynamical vehicle model is same as considered in [19] and the constants are as defined in [19] and [17].

The dynamic equations the LKAS module without driver inputs are given by:

\dot{θ}_{c}(t)=ω_{c}(t) e1:

$$e 2 : \frac{d {ω}_{c}}{dt} = {\dot{ω}}_{c} ( t )$$

$$e 3 : {T}_{sen} ( t ) = {K}_{C} [ {θ}_{c} ( t ) - \frac{{x}_{r} ( t )}{{r}_{p}} ]$$

$$e 4 : {\dot{ω}}_{c} ( t ) = \frac{1}{{J}_{c}} [ {T}_{sen} ( t ) + ( - {B}_{c} ) {ω}_{c} ( t ) ]$$

\dot{θ}ₘ(t)=ωₘ(t) e5:

$$e 6 : \frac{d {ω}_{m}}{dt} = {\dot{ω}}_{m} ( t )$$

$$e 7 : {\dot{ω}}_{m} ( t ) = \frac{1}{{J}_{m}} [ {T}_{m} ( t ) - {K}_{m} {θ}_{m} ( t ) + {K}_{m} {G}_{g} {x}_{r} ( t ) + ( - {B}_{m} ) {ω}_{m} ( t ) ]$$

\dot{x}ᵣ(t)=vᵣ(t) e8:

$$e 9 : \frac{{dv}_{τ}}{dt} = {\dot{v}}_{r} ( t )$$

$$e 10 : {\dot{v}}_{r} ( t ) = \frac{1}{{M}_{r}} [ \frac{{T}_{sen} ( l )}{{r}_{p}} + \frac{{G}_{g} {K}_{m} {θ}_{m} ( t )}{{r}_{p}} + {x}_{r} ( t ) [ - \frac{{G}_{g}^{2} {K}_{m}}{{r}_{p}^{2}} - {K}_{t} ] + ( - {B}_{r} ) {v}_{r} ( t ) - \frac{{T}_{p} {c}_{f}}{{r}_{p}} δ ( t ) + \frac{{T}_{p} {c}_{f}}{{r}_{p}} {V}_{y} + \frac{{T}_{ρ} {c}_{f} {l}_{f}}{V ( t )} γ ( t ) ]$$

\dot{Y}_{y}(t)=V_{y}(t) e11:

$$e 12 : \frac{{dV}_{y}}{dt} = {\dot{V}}_{y}$$

$$e 13 : {\dot{V}}_{y} = \frac{1}{M} [ \frac{- 2 {c}_{f} {c}_{r} {V}_{y}}{V ( t )} + 2 ( {c}_{f} + {c}_{r} ) γ - 2 \frac{( {c}_{f} {l}_{f} - {c}_{r} {l}_{r} )}{V} \dot{γ} + 2 {c}_{f} δ + 2 \frac{( {c}_{f} {l}_{f} - {c}_{r} {l}_{r} )}{V} {γ}_{\dot{d} es} ]$$

$$e 14 : \frac{d γ}{dt} = \dot{γ}$$

$$e 15 : \frac{{d}^{2} γ}{{dt}^{2}} = \ddot{γ}$$

$$e 16 : \ddot{γ} = \frac{1}{{I}_{z}} [ \frac{- 2 ( {c}_{f} {l}_{f} - {c}_{r} {l}_{r} ) {V}_{y}}{V ( t )} + 2 ( {c}_{f} {l}_{f} - {c}_{r} {l}_{r} ) γ - \frac{2 ( {c}_{f} {l}_{f}^{2} + {c}_{r} {l}_{r}^{2} )}{V ( t )} \dot{γ} + 2 {c}_{f} {l}_{f} δ - \frac{2 ( {c}_{f} {l}_{f}^{2} + {c}_{r} {l}_{r}^{2} )}{V ( t )} {γ}_{\dot{d} es} ]$$

Y_{L}=Y_{y}+(γ)×LAD e17:

The equations e1-e17 can be represented in a state space form for the plant model as in equation 1. Where the state vector is given by:
[θ_{c} ω_{c} θₘ ωₘ xᵣ vᵣ Y_{y} V_{y} γ \dot{γ}]^{T}.

The input to the power steering module is the motor torque from the controller and the output is the lateral deviation Y_{L}·\dot{γ}_{des} is the desired yaw rate given as disturbance input to avoid sudden maneuvers, to enhance the user comfort.

The optimal control action to steer the vehicle back to the lane center is given by the solving the quadratic optimization problem given in e18.

$$e 18 : {\sum }_{i = 1}^{N - 1} {‖ {Y}_{{y}_{L}} ( i \vert k ) - {Y}_{r} ( i \vert k ) ‖}_{2}^{Q} + {‖ {Y}_{δ} - {δ}_{req} ‖}_{2}^{R}$$

The example attacker model used in the study is defined based on conjecture 1. Since, in this paper we focus on automotive systems, we identify the protected and unprotected sensors and actuators from analyzing the CAN Database (DBC) files from [20]. Hence an attack vector Aᵢ is added to the dynamic equation of the unprotected measurement. Also, note that redundancy in the messages published on CAN is not accounted as ARR.

The sensor and the actuator dynamics varies depending on the device and the manufacturer configuration. Thus there are multiple configurations of the sensor suite in the ALC system that OEM's implement based on the space, computational power and market value of the vehicle. e19 is the required torque T_{req} to be applied on the steering column by the motor. The LKAS calculates the required steering angle based on the sensor values on CAN and determines the required torque to be applied by the motor and publishes the value on the CAN. Thus, the actuator attack A₁ manipulates the required torque. e20e28 are sensor dynamics where A4-A8 are sensor attacks that could be implemented through attacking the CAN of the vehicle. Attacks A2, A3, and A9 are physical-world adversarial attacks on lane detection using camera as shown in [10].

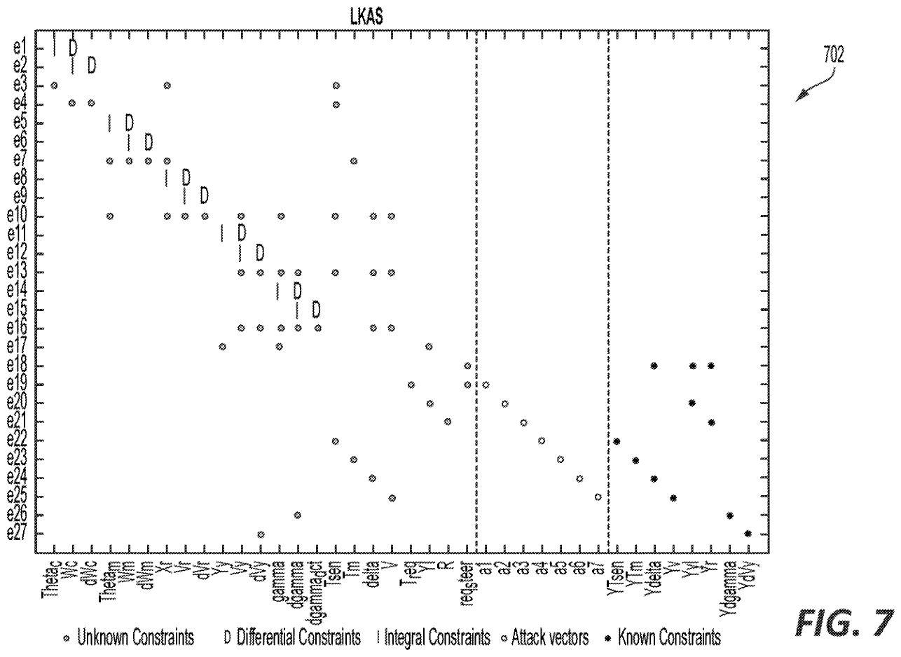

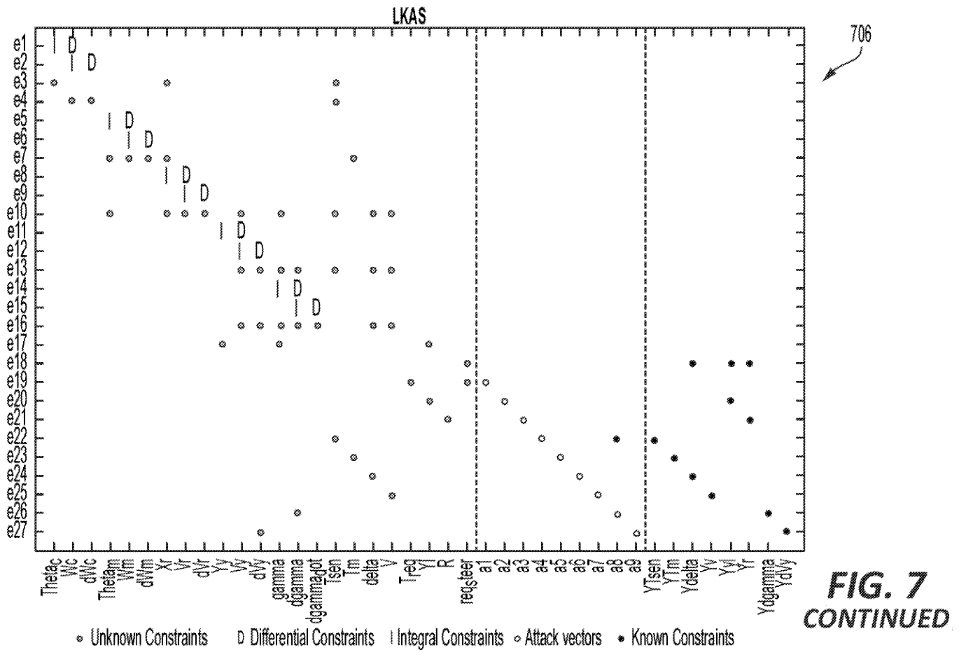

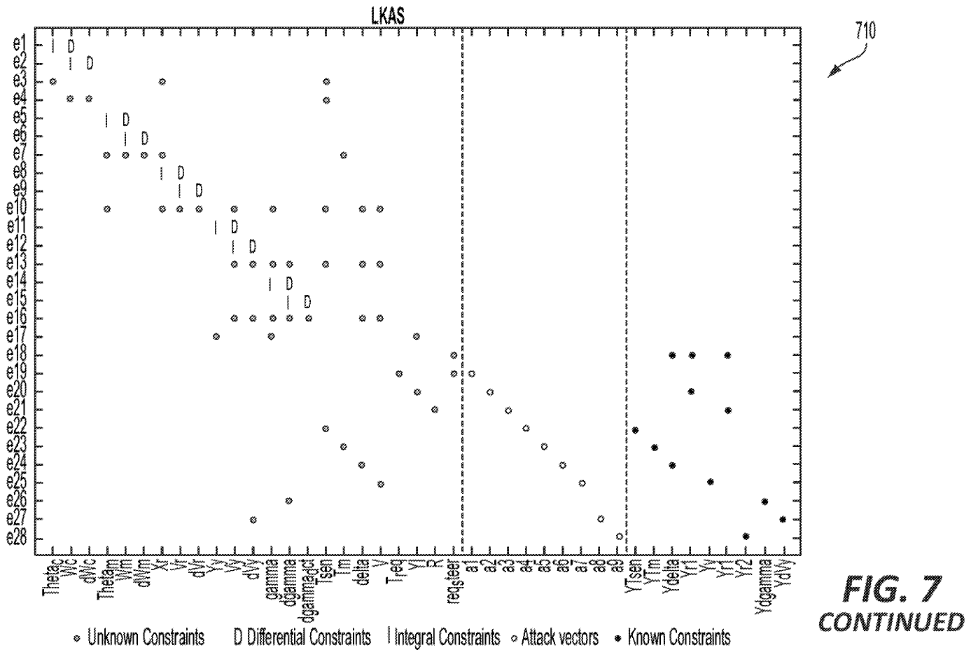

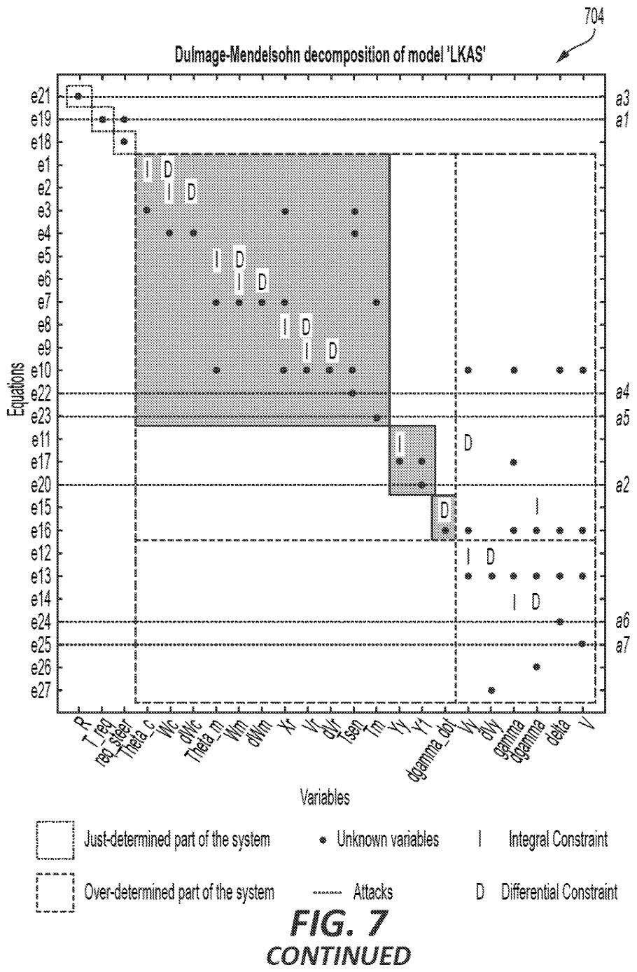

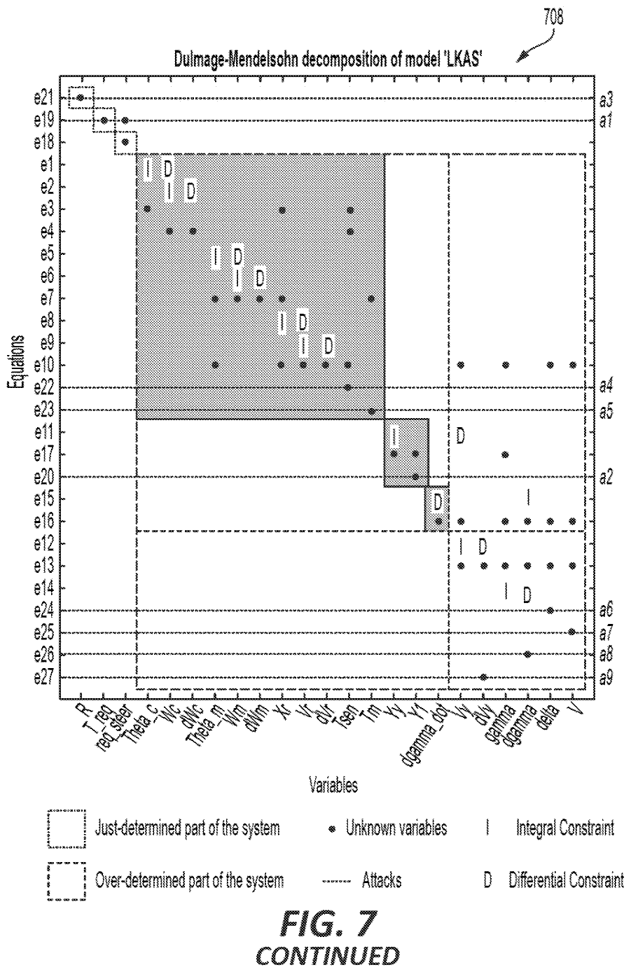

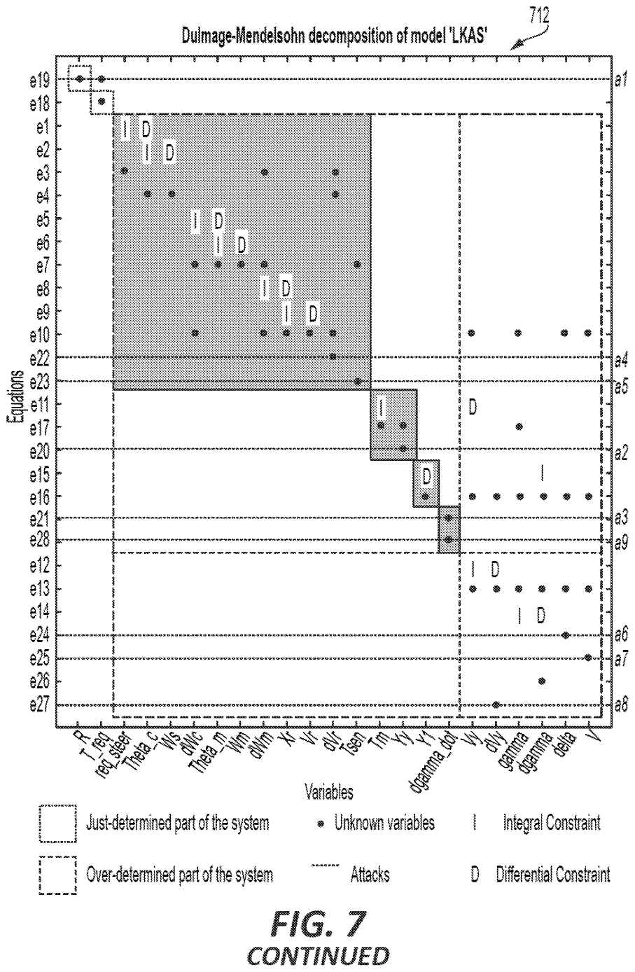

In the study, analyzing the structural model of the system included a step to identify the known and unknown parameters in the system. The unknown set of parameters (X⊂V) are not measured quantities. Hence from e1-e28, the state vector x and the set {Tₛₑₙ, Tₘ, δ, V, T_{req}, Y_{L}, R, δ_{reg}} can be the unknown parameters. While the measurements from the sensors are the known and measured parameters {Y_{Tsen}, T_{Tm}, Y_{δ}, Y_{V}, Y_{y}L, Y_{R}, Y_{R}, Y_{\dot{γ}}, Y_{\dot{V}}_{_{γ}}}. Note that the parameter is not known until it is measured using the sensor. For example, Tₛₑₙ is unknown while Y_{Tsen} from the torque sensor is known. The structural matrix of the LKAS is given in FIG. 7, where plot 702 is for car 1, plot 706 is for car 2, and plot 710 is for car 3. The DM decomposition of the LKAS is given in FIG. 7 in plot 704 for car 1, plot 708 for car 2, and plot 712 for car 3. Thus, from the DM decomposition, it is evident that the attacks a1 and a3 are not detectable.

Faults are usually defined as abnormalities in the system while attacks are precise values that are added to the system with the main intention to disrupt the performance and remain undetected by the system operator. Thus, faults are usually a subset of attack space while the attacks are targeted to break the Confidentiality, Integrity and Availability (CIA) of the system.

From the DM decomposition of the system, the study can determine that the over-determined part has more number of constraints than variables. Hence any fault or attack on the measurements from the structurally over-determined part can be determined through residues, generated with the help of ARR. The main difference between faults and attacks in terms of detectability is shown in Theorem 3.

Theorem 3: A Minimal Test Equation Support (MTES) is sufficient to detect and isolate faults while, maximizing the residues increases security index for attacks.

### Example 2

A study was performed of an example implementation of the present disclosure. The example implementation includes security risk analysis and quantification for automotive systems. Security risk analysis and quantification for automotive systems becomes increasingly difficult when physical systems are integrated with computation and communication networks to form Cyber-Physical Systems (CPS). This is because of numerous attack possibilities in the overall system. The example implementation includes an attack index based on redundancy in the system and the computational sequence of residual generators based on an assumption about secure signals (actuator/sensor measurements that cannot be attacked). This study considers a nonlinear dynamic model of an automotive system with a communication network—Controller Area Network (CAN). The approach involves using system dynamics to model attack vectors, which are based on the vulnerabilities in the system that are exploited through open network components (open CAN ports like On-Board-Diagnosis (OBD-II)), network segmentation (due to improper gateway implementation), and sensors that are susceptible to adversarial attacks. Then the redundant and non-redundant parts of the system are identified by considering the sensor configuration and unknown variables. Then, an attack index is derived by analyzing the placement of attack vectors in relation to the redundant and non-redundant parts, using the canonical decomposition of the structural model. The security implications of the residuals are determined by analyzing the computational sequence and the placement of the protected sensors (if any). Then, based on the analysis, sensor placement strategies are proposed, that is, the optimal number of sensors to protect to increase the system's security guarantees are suggested. The study verifies how the example implementation of an attack index and its analysis can be used to enhance automotive security using Model-In-Loop (MIL) simulations.

Increased autonomy and connectivity features in vehicles can enhance drivers' and passengers' safety, security, and convenience. Integrating physical systems with hardware, computation, and communication networks introduces a Cyber-Physical layer. This development of CyberPhysical Systems (CPS) paves the way for multiple security vulnerabilities and potential attacks that concern the safe operation of autonomous vehicles. Researchers have successfully exploited these vulnerabilities that potentially lead to safety and privacy hazards [1A]-[3]. Thus, the two critical aspects of the automotive system: safety and security go hand-in-hand. However, the security of CPS is more abstract, and unlike safety, it may not be defined as a functional requirement [4A]. A major roadblock can be the lack of resources to express and quantify the security of a system. This example implementation of the present disclosure studied can performing a vulnerability analysis on an automotive system and quantifying the security index by evaluating the difficulty in performing the attack successfully without the operators' (drivers') knowledge.

Faults are a major contributor to the activation of safety constraints in a system, unlike attacks that are targeted and intentional. Apart from disturbances, any deviation from the expected behavior of a system is considered a fault and may arise due to various reasons, such as malfunctioning sensors, actuators, or controllers failing to achieve their optimal control goal. The concepts of Fault-Tolerant-Control (FTC) [5A] and Fault Diagnosis and Isolability (FDI) [6A] can be used to mitigate faults in a system. A structural representation of a mathematical model can be used for determining redundancies in the system. Residuals computed from these redundancies can then be used to detect and isolate faults. In contrast, attacks exploit system vulnerabilities such as improper network segmentation (improper gateway implementation in CAN), open network components (OBD-II), or sensors exposed to external environments (GPS or camera). An attack is successful if it is stealthy and not detected in the system [7A]. The system will show a failed attack as an abnormality or a fault and will alert the vehicle user.

An observable system with Extended Kalman Filter (EKF) and an anomaly detector are attackable [8A], and the sensor attack is stealthy as long as the deviation in the system states due to the injected falsified measurement is within the threshold bounds. This additive attack eventually drives the system to an unsafe state while remaining stealthy. However, the attack proposed is complex in time and computation as multiple trial-and-error attempts are required to learn a stealthy attack signal. Also, the stealthy execution of the attack becomes very complex due to the dynamic nature of driving patterns. Also, the attack fails if the system uses a more complex anomaly detector like CUmulative SUM (CUSUM) or Multivariate Exponentially Weighted Moving Average (MEWMA) detectors instead of the standard ChiSquared detectors. Apart from observer-based techniques, the anomaly detectors could also be designed based on the system's redundancies and still involve the tedious procedure of identifying the specific set of attack vectors to perform a stealthy, undetectable attack.

There are limited methods available for analyzing and quantifying security risks in automotive systems. A security index [9A] can represent the impact of an attack on the system. This [10A] defines the condition for the perfect attack as the residual R(t)→0, ∀t>0. An adversary can bias the state away from the operating region without triggering the anomaly detector. Based on the conditions for perfect attackability, a security metric can identify vulnerable actuators in CPS [11A]. The security index can be generic using graph theoretic conditions, where a security index is based on the minimum number of sensors and actuators that needs to be compromised to perform a perfectly undetectable attack. That example can perform the minimum s-t cut algorithm—the problem of finding a minimum cost edge separator for the source (s) and sink (t) or the input (u) and output (y) in polynomial time. [12A] However, these security indices, designed for linear systems, do not analyze the qualitative properties of the system while suggesting sensor placement strategies. Also, their security indices do not account for the existing residuals used for fault detection and isolation. Sets of attacks, such as replay attacks [14A], zero-dynamics attacks [15A], and covert attacks [16A], make the residual asymptotically converge to zero, similar to the class of undetectable attacks. But the detection techniques that work for undetectable attacks fail for stealthy integrity attacks. [11A, 13A]

The example implementation of the present disclosure includes a robust attack index and includes design of sensor configurations and variations to the automotive system parameters to minimize the attack index are suggested, which in turn, increases the security index of the system. This approach of analyzing the security index of the system is an addition to [17A], which performs vulnerability analysis on nonlinear automotive systems. The example implementation described herein can identify the potential vulnerabilities that could be exploited into attacks in an automotive system. These are generally the sensor/actuator measurements that are openly visible on CAN and sensors exposed to external environments that are susceptible to adversarial attacks. They are categorized as unprotected measurements. A system model (e.g., a grey-box model with input-output relations [17A]) is defined, and the redundant and non-redundant parts of the system can be identified using canonical decomposition of the structural model. The attacks are then mapped to the redundant and non-redundant parts. Structural analysis [6A] can show that anomalies on the structurally redundant part are detectable with residuals. The study of the example implementation evaluates different residual generation strategies and suggests the a most secured sequential residual among various options with respect to the sensor placement. Then the most critical sensor to protect to reduce the attack index and improve the overall security of the system can be suggested. As used in the study described herein, it is assumed that the protected sensors cannot be attacked.

The example implementation of the present disclosure can include any or all of:

(A) An attack index for an automotive system based on the canonical decomposition of the structural model and sequential residual generation process is derived, where the attack index is robust to nonlinear system parameters.

(B) The proposed attack index weighs the structural location of the attack vectors and the residual generation process based on the design specifications. The complexity of attacking a measurement is based on the redundancy of that measurement in the system and if that redundant measurement is used for residual generation.

(C) To reduce the attack index, a most suitable set of sensor measurements to protect is identified by analyzing the structural properties of the system. Then, sequential residuals are designed using the set of protected sensors to avoid perfectly undetectable attacks and stealthy integrity attacks. This strategy works well with the existing fault diagnosis methods, is cost efficient (in avoiding redundant sensors), and can give Original Equipment Manufacturers (OEMs) freedom to implement the security mechanisms of their choice. The results of the study are validated using MIL simulations with the example implementation.

FIG. 3 illustrates an example feedback control system with a network layer between the controller and actuator. The attacker attacks the system by injecting signals by compromising the network or performing adversarial attacks on sensors.

The study of the example implementation includes a system model.

A cyber-physical system can be defined by nonlinear dynamics

\dot{x}(k)=ƒ(x(k))+g(x(k))u(k)

y(k)=h(x(k))

where x∈ [symbol] ⁿ, u∈ [symbol] ^{q} and y∈ [symbol] ^{m} are the state vector, control input, and the sensor measurements. Based on [18A] and [19A], the nonlinear system can be uniformly observable. That is, ƒ, g, and h are smooth and invertible. The linearized—Linear Time-Invariant (LTI) version of the plant is given by ƒ(x(k))+g(x(k)u(k)=Axₖ+Buₖ and yₖ=CXₖ where A∈ [symbol] ^{n×n}, B∈ [symbol] ^{n×q}, and C∈ [symbol] ^{m×n} are the system, input, and output matrices respectively.

The study of the example implementation includes an attacker model.

The attacker model can be given by:

u^{c}(k)=u(k)+a^{a}(k)

y^{c}(k)=y(k)+a^{s}(k)

where a^{a}(k)∈ [symbol] ^{p}^{₁} and a^{s}(k)∈ [symbol] ^{p}^{₂} are the actuator and sensor attack vectors (p₁+p₂=p). The compromised state of the system at any time (k) can be linearized as

$${\dot{x}}_{i}^{c} ( k ) = {\sum }_{j = 1}^{n} {A}_{ij} {x}_{j} ( k ) + {\sum }_{j = 1}^{q} {B}_{ij} {u}_{j} ( k ) + {B}_{a , ij} {a}_{a , j} ( k ) .$$

### Where

$${u}_{i}^{c} ( k ) = {B}_{a , ij} {a}_{a , j} ( k )$$

is the actuator attack signal injected by the attacker. Similarly,

$${y}_{i}^{c} ( k ) = {\sum }_{j = 1}^{n} {C}_{ij} {x}_{j} ( k ) + {C}_{s , ij} {a}_{s , j} ( k )$$

is a compromised sensor measurement and a_{s,i}(k) is the attack injected. u′(k)∈ [symbol] ^{q-p}^{₁} and y′(k)∈ [symbol] ^{m-p}^{₂} are the noncompromised actuator and sensor signals.

Assumption 1: For any system, protected measurements cannot be compromised. The sensor and actuator measurements that can be attacked are unprotected measurements, and those measurements that cannot be attacked are protected measurements.

Note that there are multiple ways to protect a sensor or actuator measurement, and it is mostly application and network configuration specific. Techniques on how to select a sensor measurement to protect are discussed throughout the present disclosure.

The study of the example implementation includes a structural model.

The structural model is used to analyze the system's qualitative properties to identify the analytically redundant part [6A]. The free parameters in a system realization are the non-zero positions in the structural matrix [12A]. The structural model M is given by M=(ε,X) where ε is the set of equations or constraints ε={e₁, e₂, . . . } and X is the set of variables X={x₁, x₂ . . . , xₙ, u₁, u₂, . . . , u_{q}, y₁, y₂, . . . , yₘ, a₁, a₂, . . . , aₚ} that contain the state, input, output and the attack vectors. The variables can be further grouped as known Z⊂X and unknown X⊂X. The model M can be represented by a bipartite graph G=(X∪ε, Γ). In the bi-partite graph, the existence of variables in an equation is denoted by an edge Γ={(eᵢ, xⱼ)|xⱼ in eᵢ, xⱼ∈X, i∈[1, 2, . . . , r], j∈[1, 2, . . . , n+m+q]}. The structural model M can also be represented as an adjacency matrix—a Boolean matrix with rows corresponding to ε and columns to X. M_{i×j}={m_{i,j}|m_{i,j}=1 if (eᵢ, xⱼ)∈Γ, 0 otherwise}.

Definition 1: (Matching) Matching on a structural model M is a subset of Γ such that two projections of any edges in M are injective. This indicates that any two edges in G do not share a common node. A matching is maximal if it contains the largest number of edges (maximum cardinality) and perfect if all the vertices are matched. The non-matched equations of the bipartite graph represent the Analytically Redundant Relations (ARR).

Structural analysis can be performed to identify matchings in the system. An unknown variable can be calculated from a constraint or an equation. If they are mapped to multiple constraints, then they contribute to redundancy in the system, which can be used for abnormality detection. Based on the redundancy, the system can be divided into three submodels: under-determined (no. of unknown variables>no. of constraints), just-determined (no. of unknown variables=no. of constraints), and over-determined part (no. of unknown variables<no. of constraints). The different parts (underexactly and over-determined parts) of the structural model M can be identified by using the DMD. DMD is obtained by rearranging the adjacency matrix in block triangular form. The under-determined part of the model is represented by G⁻ with node sets ε⁻ and X⁻ the just-determined part is represented by G⁰ with node sets ε⁰ and X⁰, and the over-determined part is represented by G⁺ with node sets ε⁺ and X⁺. The just and over-determined parts are the observable part of the system. Attack vectors in the under-determined (a⁻) and just determined (a⁰) part of the system are not detectable. While Attack vectors in the over-determined (a⁺) part of the system are detectable with the help of redundancies [6A], which can be used to formulate residuals for attack detection.

The example implementation of the present disclosure can include methods of determining an attackability index.

The attackability index can be based on the number of vulnerabilities in the system, which could potentially be exploited into attacks, i.e., it is proportional to the number of sensors and actuators that can be compromised or the number of unprotected measurements in the system. Thus, larger the attack index, the more vulnerable the system.

Let

$$a = [ \begin{matrix}{a}^{a} \\ {a}^{s}\end{matrix} ] ∈ {\text{?}}^{p}$$

be the attack vector. The attackability index α is proportional to the number of non-zero elements in a and is given by:

$$α = \vert {\sum }_{j = 1}^{p} {( {W}_{i}^{a} )}_{j} + {\sum }_{j = 1}^{{‖ R ‖}_{0}} {( {W}_{i}^{r} )}_{j} \vert$$

Where Wᵢ^{a} is the penalty added depending on the attack, based on whether the attack vector is in the under, just, or overdetermined part. Thus for every attack vector in a, a penalty Wᵢ^{a} is added to the index α. The attack becomes stealthy and undetectable if it is in the under or just-determined part of the system, and at the same time, it is easier to perform the attack. Hence a larger penalty is added to α. If the attack is in the over-determined part, the complexity of performing a stealthy attack increases drastically due to the presence of redundancies. Hence a smaller penalty is added. R denotes the residuals in the system for anomaly detection, and (Wᵢ^{r}) are the weights added to incentivize the residuals for attack detection based on the residual generation process. Similar to attacks, for every residue in the system, a weight (Wᵢ^{r}) is added.

The overall security goal of the example system is to minimize the attackability index: minimize α with respect to the attacker model as defined in (2) and maximize the number of protected residuals when a≠0. This security goal can be achieved in two ways: (i) Replace unprotected measurements with protected measurements. However, this is not feasible as it requires a drastic change in the In-Vehicle Network (IVN). Research along this direction can be found in [20A](ii) Introduce redundancy in the system to detect abnormalities. With redundancy in the system, residuals can be generated, and a detector can be designed to identify abnormalities. In this way, the system might still be susceptible to attacks, but a stealthy implementation of the attack is arduous as the attacker must compromise multiple measurements. Suppose the attacker fails in performing a stealthy attack, the abnormalities in the measurements introduced by the attacker are shown as faults in the system, and the vehicle user is alerted of potential risks.

Preliminaries and definitions are used herein [17A]. Consider the system and attacks as discussed in (1) and (2). From the G⁺ part of the DMD, residuals can be generated using the redundant constraints and can be checked for consistency. The structure of the residual is the set of constraints monitorable sub-graphs with which they are constructed. The monitorable sub-graphs are identified by finding the Minimal Structurally Over-determined (MSO) set as defined in [21A].

Definition 2: (Proper Structurally Over-determined (PSO)) A non-empty set of equations E≠Ø is a PSO set if ε=ε⁺.

The PSO set is a testable subsystem, which may contain smaller subsystems—MSO sets.

Definition 3: (Minimal Structurally Over-determined (MSO)) A PSO set is an MSO set if no proper subset is a PSO set.

MSO sets are used to find a system's minimal testable and monitorable sub-graph.

Definition 4: Degree of structural redundancy is given by φ(ε)=|ε⁺|−|X⁺|

Lemma 1: If ε is a PSO set of equations with e∈ε, then φ(ε\{e})≥φ(ε)−1.

Lemma 2: The set of equations ε is an MSO set if and only if ε is a PSO set and φ(ε)=1

The proof of Lemma 1 and Lemma 2 is given in [21A] by using Euler's totient function definition [22A].

For some MSO sets identified according to Lemma 2, a set of equations called the Test Equation Support (TES) can be formed to test for faults or attacks. A TES is minimal (MTES) if there exist no subsets that are TES. Thus, MTES leads to the most optimal number of sequential residuals by eliminating unknown variables from the set of equations (parity-space-like approaches).

Definition 5: (Residual Generator) A scalar variable R generated only from known variables (z) in the model M is the residual generator.

The anomaly detector looks if the scalar value of the residual (usually a normalized value of residual Rₜ) is within the threshold limits under normal operating conditions. Ideally, it should satisfy lim_{t→∞}R(z)=0 (zero-mean).

An MTES set might involve multiple sensor measurements and known parameters in the residual generation process. The generated residual is actively monitored using an anomaly detector (like the Chi-squared detector).

The system as defined in (1) is not secure if (i) There exists an attack vector that lies in the structurally under or just determined part. The consequence of the attack is severe if there is a significant deviation of the state from its normal operating range. lim_{t→∞}∥Δx(t)∥=∞ is the unbounded condition for the attack sequence.

Note that a similar definition would be sufficient for any anomaly detector. This work focuses on compromising the residual generation process and not the residual evaluation process—the residual is compromised irrespective of the evaluation process. The measurements from the system are categorized as protected and unprotected measurements. From the system definition, it is inferred that not all actuators and sensors are susceptible to attacks. Thus, the attacker can inject attack signals only to those vulnerable, unprotected sensors and actuators.

The example implementation can determine an attack index of a system.

The attack index is determined according to (3), and this section discusses how the weights for the attack index in (3) are established.

A vertex is said to be reachable if there exists at least a constraint that has an invertible edge (e, x). As used in the present example, an attack weight of the scale

$${W}^{a} = {W}_{1}^{a} < {W}_{2}^{a} … ,$$

is used, where

$${W}_{1}^{a}$$

represents the penalty for a stealthy attack vector that is very hard to implement on the system due to the presence of residuals and anomaly detectors and Wᵢ^{a}(∀i>1) represents the penalty for an attack vector that compromises the part of the system without residuals and anomaly detectors. For example, a safety critical component without any security mechanism to protect it will have a very large weight (say, W_{∞}^{a}).

Similarly, the weight of the residuals is of the scale

$${W}^{r} = {W}_{1}^{r} < {W}_{2}^{r} … .$$

### Where

$${W}_{1}^{r}$$

represents the residuals that cannot be compromised easily and

$${W}_{i}^{r} ( ∀ i > 1 )$$

represents the residuals that can be compromised easily. Note that the weights are not fixed numbers as they can be changed based on the severity of the evaluation criterion and could evolve based on the system operating conditions.

Proposition 1: The just or under-determined part of the system with unprotected sensors and actuators has a high attack index:

$$( {W}^{a} = {W}_{i}^{a} ( ∀ i > 1 ) ) .$$

Proof: Undetectable attack vectors from sensors and actuators are the primary reason for the higher attack index. Due to the lack of residuals, the attack vector aᵢ is not detectable. From definitions 3, 4, lemma 1, and 2:

ε⁰∉MSO⇒φ(ε⁰)=0.

Any attack on ε⁰ is not detectable as residual generation is not possible. For the just-determined part of the system, anomaly detection can only be achieved by introducing redundancy in the form of additional sensors or prediction and estimation strategies. The over-determined portion of the system can still be vulnerable to attacks; however, these attacks can be detected through the residuals generated from MSO sets. Thus, the complexity of performing a successful attack is high, which leads to proposition 2.

Proposition 2: The over-determined part of the system with unprotected sensors and actuators is still attackable and has a low attack index due to the complexity of performing an attack:

$$( {W}^{a} = {W}_{1}^{a} ) .$$

Proof: From assumption 1, the system is attackable if it has unprotected sensors and actuators. To perform a stealthy attack, the attacker should compromise the unprotected sensors without triggering any residuals. Hence, the condition for detectability and existence of residuals is from definition 5, R(z)=0 is an ARR for all z∈O where O is the set of observations in the model [symbol] . The ARRs are from complete matchings from [symbol] in MSO sets, provided the ARRs are invertible and variables can be substituted with consistent causalities.

The condition for the existence of residuals in linear systems is discussed in [23A] and non-linear systems in [24A]. Proposition 2 shows that unprotected measurements cause vulnerabilities in the system that could lead to attacks. However, these attacks are detectable with residuals in the system. Thus, strategies to evaluate residuals are described herein.

From the DMD of the system, it is inferred that the overdetermined part has more constraints than variables. Hence any fault or attack on the measurements from the structurally overdetermined part can be detected through residuals generated with the help of ARR. So, this section suggests a criterion for the placement of protected sensors for a sequential residual generation to maximize the system's security.

For a residual R, consider a matching M with an exactly determined set of equations E. Let bᵢ be a strongly connected component in M with Mᵢ equations if eᵢ∈Mᵢ be the set of equations measuring variables in bᵢ. Also, bᵢ is the maximum order of all blocks in M. Let A∈M be the set of structurally detectable attacks. Let Pₛ⊆X be the set of possible sensor locations that could be protected, S_{D} denote the secured detectability of attacks, and [Aᵢ] denote the set of equivalent attacks.

Theorem 1: Then, maximal security through attack detectability of A∈M is achieved by protecting the strongly connected component in the sequential residual:

∃S_{D}([Aᵢ])⇔(bᵢ>bⱼ)∈yₜ

Proof: From the definition of DMD [25A] and Definition 4, for M, the family of subsets with maximum surplus is given by

L={E⊆M|φ(E)≥φ(E′),∀E′⊆M}

Where L is the sublattice of M. Also, φ({eᵢ}∈E)=1⇒Mⱼ⊆E and for the partial order sets Mⱼ<Mᵢ∀E∈L(Mᵢ⊆E⇒Mⱼ⊆E). Thus, the minimal set E in L such that eᵢ measures Mᵢ>Mⱼ achieves maximal detectability.

Theorem 1 shows that securing the strongly connected component can detect attacks that affect that component. In other words, an attack in a strongly connected component compromises all its sub-components as they are in the same equivalence relation. From [25A], it is evident that measuring the block with the highest order gives maximum detectability. Similarly, here we say that attack on the block with the highest order gives maximum attackability. The highest block component can also be a causal relation of a protected measurement.

An alternate way of Theorem 1 can be stated as follows: A secured sequential residual for attack detection and isolation has matching with a protected state of the system at the highest ordered block. The residual equation is formulated with the protected measurement and estimate of that measurement. Since it is assumed that system (1) is uniformly observable, the protected measurement could be observed from other measurements. The strongly connected component can be estimated from other measurements and can be compared with the protected sensor measurement. This comparison can be used to find faults/attacks on the measurements that were used to compute the strongly connected component.

Thus, a residual Rᵢ generated from M with {Aᵢ∈Mᵢ}∈bᵢ is attackable as A belongs to the same equivalence class. Also, if bⱼ<bᵢ is a block of the order less than that of bᵢ. Then residual Rᵢ∈bᵢ from M with {Aⱼ∈Mⱼ}∈bⱼ can be detected as Rᵢ has maximum detectability and {Aⱼ∉bᵢ}. That is, there are no attacks in the block of maximum order. Hence, from theorem 1, the following can be formulated:

residuals computed with unprotected sensors are attackable and have (W^{r})=Wᵢ^{r}(∀i>1)

While residuals computed with protected sensors are more secure and have (W^{r})=W₁^{r}

Also, the alt of Theorem 1 can be used to identify the critical sensors that must be protected to maximize the overall security index of the system.

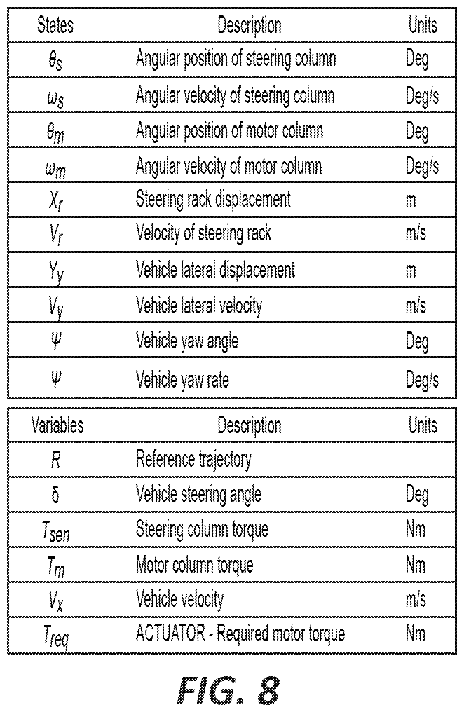

The study included an example implementation including Automated Lane Centering System (ALC). A complete Lane Keep Assist System (LKAS) with vehicle dynamics, steering dynamics, and the communication network (CAN) was considered, and example parameters for the example lane keep assist system are shown in FIG. 8.

A controller, typically either a Model Predictive Controller (MPC) [26A] or a Proportional-Integral-Derivative (PID) controller [27A], is employed as demonstrated in the LKAS shown in FIG. 9. Its purpose is to actuate a DC motor that is linked to the steering column, thereby directing the vehicle towards the center of the lane. The LKAS module has three subsystems: (i) the vehicle's lateral dynamics control system [e1-e6] and its sensor suite [e8-e13], (ii) the steering system—steering column [e14-e17], the power assist system [e18-e20], and steering rack [e21-e23] with sensor suite [e24-e26]. In the LKAS setup, an Electronic Control Unit (ECU) is utilized, which is equipped with sensors to detect various vehicle parameters such as steering torque, steering angle, lateral deviation, lateral acceleration, yaw rate, and vehicle speed. The mechanical arrangement of the LKAS and the dynamic model of the vehicle is as discussed in [28A]. The parameters of LKAS and the constants are as defined in [29A] and [26A].

The dynamic equations of the LKAS module without driver inputs at time t are given by:

$$\frac{{dY}_{y}}{dt} = {V}_{y} \qquad e1$$

$$\frac{d {V}_{y}}{d t} = {\dot{V}}_{y} \qquad e2$$

$${\dot{V}}_{y} = \frac{1}{M} [ - {C}_{f} {α}_{f} {μ}_{f} \frac{{l}_{r} M g - ( {\dot{V}}_{x} - {V}_{y} \dot{ψ} ) M h}{1000 ( {l}_{f} + {l}_{r} )} \cdot cos ( δ ) - {C}_{r} {α}_{r} {μ}_{r} \frac{{l}_{f} M g - ( {\dot{V}}_{x} - {V}_{y} \dot{ψ} ) M h}{1000 ( {l}_{f} + {l}_{r} )} ] - {V}_{x} \dot{ψ} \qquad e3$$

$$\frac{d ψ}{dt} = \dot{ψ} \qquad e4$$

$$\frac{d \dot{ψ}}{d t} = \ddot{ψ} \qquad e5$$

$$\ddot{ψ} = \frac{1}{{I}_{Z}} [ - {l}_{f} {C}_{f} {α}_{f} {μ}_{f} \frac{{l}_{r} Mg - ( {\dot{V}}_{x} - {V}_{y} \dot{ψ} ) Mh}{1000 ( {l}_{f} + {l}_{r} )} \cdot cos ( δ ) - {l}_{r} {C}_{r} {α}_{r} {μ}_{r} \frac{{l}_{f} Mg - ( {\dot{V}}_{x} - {V}_{y} \dot{ψ} ) Mh}{1000 ( {l}_{f} + {l}_{r} )} ] \qquad e6$$

$$Where {α}_{f} = {tan}^{- 1} ( \frac{{V}_{y} + {l}_{f} \dot{ψ}}{{V}_{x}} ) - δ and$$

$${α}_{r} = {tan}^{- 1} ( \frac{{V}_{y} - {l}_{r} \dot{ψ}}{{V}_{x}} )$$

$${τ}_{r e q} = \frac{1}{η {r}_{g}} ( \frac{0.94}{1 - 0.117 {cos}^{2} {Y}_{{θ}_{s}}} ) ( {K}_{t} [ \frac{{tan}^{- 1} {Y}_{{θ}_{s}}}{0.94} - {r}_{s} δ ] ) + ( {A}_{1} ) \qquad e7$$

$${Y}_{{Y}_{y}} = {Y}_{y} + ( {A}_{2} ) \qquad e8$$

$${Y}_{R} = R + ( {A}_{3} ) \qquad e9$$

$${Y}_{ψ} = ψ + ( {A}_{4} ) \qquad e19$$

$${Y}_{{V}_{x}} = {V}_{x} + ( {A}_{5} ) \qquad e11$$

$${Y}_{\dot{ψ}} = \dot{ψ} + ( {A}_{6} ) \qquad e12$$

$${Y}_{{\dot{V}}_{y}} = {\dot{V}}_{y} + ( {A}_{7} ) \qquad e13$$

$$\frac{d {θ}_{s}}{dt} = {ω}_{s} \qquad e14$$

$$\frac{d {ω}_{s}}{dt} = {\dot{ω}}_{s} \qquad e15$$

$${T}_{s e n} = {K}_{s} [ {θ}_{s} - \frac{{x}_{r}}{{r}_{p}} ] \qquad e16$$

$${\dot{ω}}_{s} = \frac{1}{{J}_{s}} [ {T}_{s e n} + ( - {B}_{s} ) {ω}_{s} ] \qquad e17$$

$$\frac{d {θ}_{m}}{dt} = {ω}_{m} \qquad e18$$

$$\frac{d {ω}_{m}}{dt} = {ω}_{m} \qquad e19$$

$${\dot{ω}}_{m} = \frac{1}{{J}_{m}} [ {T}_{m} - {K}_{m} {θ}_{m} + \frac{{K}_{m} {G}_{g} {x}_{r}}{{r}_{p}} + ( - {B}_{m} ) {ω}_{m} ] \qquad e20$$

$$\frac{d {x}_{r}}{dt} = {v}_{r} \qquad e21$$

$$\frac{{dv}_{r}}{dt} = {\dot{v}}_{r} \qquad e22$$

$${\dot{v}}_{r} = \frac{1}{{M}_{r}} [ \frac{{T}_{s e n}}{{r}_{p}} + \frac{{G}_{g} {K}_{m} {θ}_{m}}{{r}_{p}} + {x}_{r} [ - \frac{{G}_{g}^{2} {K}_{m}}{{r}_{p}^{2}} - {K}_{t} ] + ( - {B}_{r} ) {v}_{r} ( t ) - \frac{{T}_{p} {c}_{f}}{{r}_{p}} δ + \frac{{T}_{p} {c}_{f} {l}_{f}}{{V}_{x}} ψ ] \qquad e23$$

Y_{θ}_{ₛ}=±θₛ+(A₈) e24:

Y_{Tsen}=Tₛₑₙ+(A₉) e25:

Y_{Tm}=Tₘ+(A₁₀) e26:

The dynamic equations described above are non-linear. The structural analysis is qualitative and is oriented towards the existence of a relationship between the measurements rather than the specific nature of the relation (like linear or nonlinear relation). The analysis remains valid until the nonlinear functions are invertible. However, the nonlinear dynamic equations can be approximately linearized around the operating point if needed. The state vector is given by: x=[θₛ ω_{w} θₘ ωₘ xᵣ vᵣ Y_{y} V_{y} ψ \dot{ψ}]^{T}

The attacker model used in the example implementation is defined based on assumption 1. Since the study focuses on automotive systems, the protected and unprotected measurements are identified by reading the CAN messages from the vehicle and analyzing them with the CAN Database (DBC) files from [31A], and adding an attack vector Aᵢ (where i is the attack vector number) to the dynamic equation of the unprotected measurements. The unprotected measurements are the ones that are openly visible on CAN and camera measurements that are susceptible to adversarial attacks. Also, note that redundancy in the messages published on CAN is not accounted as ARR.

Based on the information obtained from the sensors on the CAN, the LKAS computes the necessary steering angle and torque to be applied to the motor. The calculated values are transmitted through the CAN, which the motor controller uses to actuate the motor and generate the necessary torque to ensure that the vehicle stays centered in the lane. The actuator attack A₁ manipulates the required torque. When the torque applied to the motor is not appropriate, it can result in the vehicle deviating from the center of the lane. e8-e13 and e24e26 are sensor dynamics where A₂-A₁₀ are the sensor attacks. Attacks A₂ and A₃ are physical-world adversarial attacks on perception sensors for lane detection as shown in [32A]. Other attacks are implemented through the CAN.

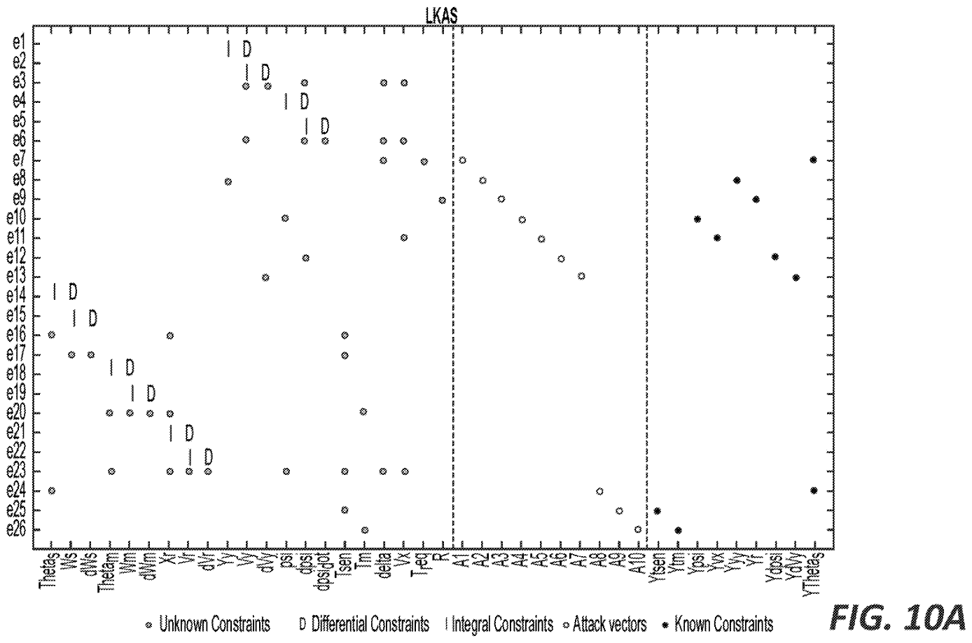

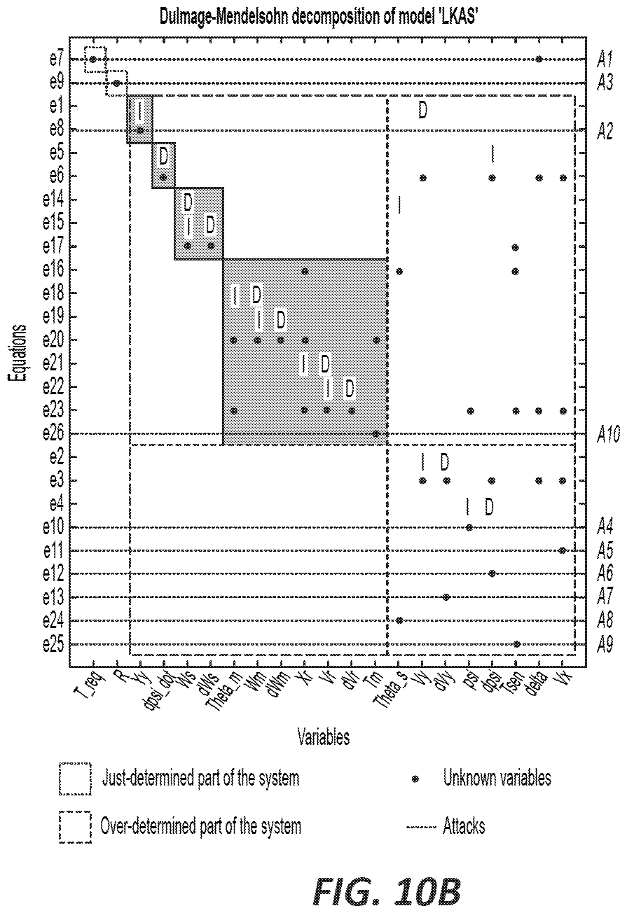

An example step in structural analysis is to identify the known and unknown parameters. The parameters that are not measured using a sensor are unknown (X⊂X). From the dynamic equations, we have the state vector x and the set {Tₛₑₙ, Tₘ, δ, Vₓ, T_{req}, R,} as unknown parameters. The measurements from the sensors are the known parameters {Y_{Tsen}, Y_{Tm}, Y_{ψ}, Y_{V}_{ₓ}, Y_{Y}_{_{y}}, Y_{R}, Y_{\dot{ψ}}, Y_{\dot{V}}_{_{y}}, Y_{θ}_{ₛ}}. Note that a parameter is unknown in the study until it is measured using the sensor. For example, Tₛₑₙ is unknown while Y_{Tsen} from the torque sensor is known. The structural matrix of the LKAS is given in FIG. 10A, and the DMD of the LKAS is given in FIG. 10B. The dot in the structural matrix and DMD implies that the variable in X-axis is related to the equation in Y-axis. From the DMD, it is clear that the attacks on the just-determined part—A₁ and A₃ are not detectable and other attacks on the over-determined part are detectable. The equivalence class is denoted by the grey-shaded part in the DMD (FIG. 10B), and the attacks on different equivalence classes can be isolated from each other with test equations or residuals. steering module is the motor torque from the controller. \dot{ψ}_{des} can be given as the desired yaw rate as a disturbance input to avoid sudden maneuvers, to enhance the user comfort [26A]. The optimal control action to steer the vehicle back to the lane center is given by solving the quadratic optimization problem with respect to the reference trajectory:

$${\sum }_{i = 1}^{N - 1} {‖ {Y}_{{Y}_{y}} ( i \vert k ) - {Y}_{R} ( i \vert k ) ‖}_{2}^{Q} + {‖ {Y}_{ψ} - δ ‖}_{2}^{R}$$

Equation (e7) is the required motor torque calculated by the controller. The steering wheel torque (e25), wheel speed (e11), yaw rate (e12), and lateral acceleration (e13) sensors have been mandated by National Highway Traffic Safety Administration (NHTSA) for passenger vehicles since 2012 [30A].

The attacks A₂, A₄-A₁₀ are detectable and isolable. The residuals generated (TES) that can detect and isolate the attacks are given by the attack signature matrix in 11. The dot in the attack signature matrix represents the attacks in the X-axis that the TES in Y-axis can detect. For example, the TES-1 (residual-1) can detect attacks 6 and 7.

The study considered hypothetical cases by modifying the sensor placement for the residual generation to derive the overall attack index. In the present example, the most safety-critical component of the LKAS—Vehicle dynamics and its sensor suite is considered for further analysis [e1-e13]. The LKAS is simulated in Matlab and Simulink to evaluate the attacks, residuals, and detection mechanism [33A]. The structural analysis is done using the fault diagnosis toolbox [34A]. Let us assume the following weights for W^{a} and W^{r}:

$${W}_{1}^{a} = 1 and {W}_{i}^{a} ( ∀ i > 1 ) = 10$$

$${W}_{1}^{r} = 1 and {W}_{i}^{r} ( ∀ i > 1 ) = 10$$

All the attacks and residuals are equally weighted for the sake of simplicity. It should be understood that the attacks and residuals can have any weight, and that the weights provided herein are only non-limiting examples.

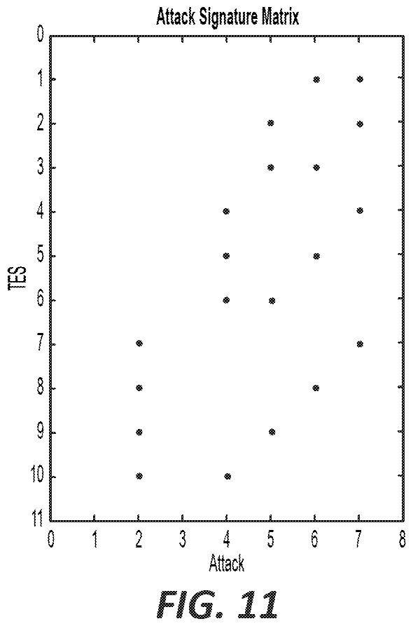

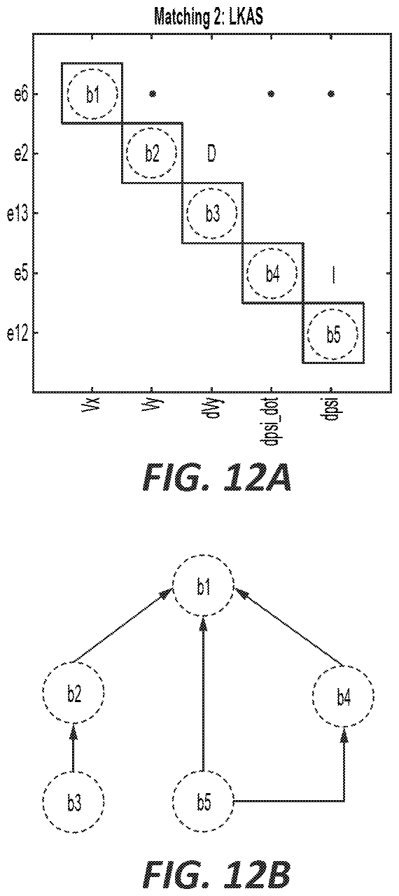

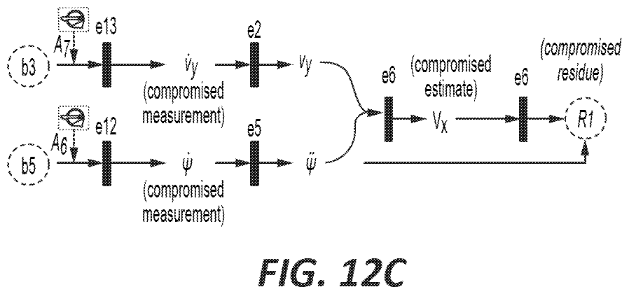

The study included simulations to support the propositions 1 and 2. For the scope of this paper, only the residual plots and analysis for TES-1 (FIG. 11) are shown. However, the analysis could be easily extended to all the TES and even larger systems. TES-1 is generated from the equation set: {e2, e3, e5, e6, e12, e13}. For the attacks on the just determined part, A₁—actuator attack is simulated, and attack A₃ is as shown in [32A]. Assuming that there are no protected sensors, the residuals are generated from the most optimal matching—the one with minimum differential constraints to minimize the noise in the residuals (low amplitude and high-frequency noise do not perform well with differential constraints). The residual generation process for TES-1 is shown in FIGS. 12A-12C. For example, the residual generated for the sensor placement with graph matching as shown in FIG. 12A Matching-2 has the Hasse Diagram as shown in FIG. 12B and computational sequence as shown in FIG. 12C.

The following results of the study illustrate the effectiveness of the example implementation through simulations:

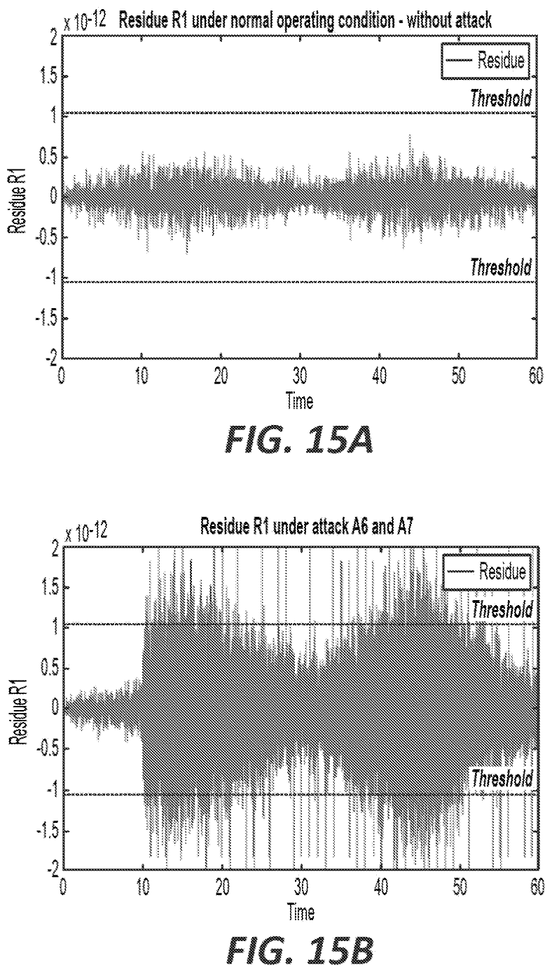

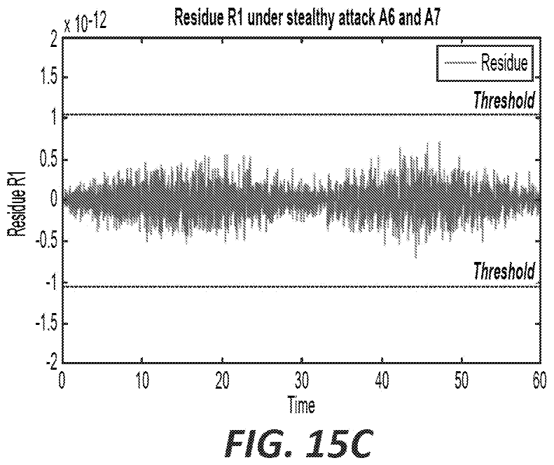

TES-1 (residual R₁) to detect attacks A₆ and A₇ under non-stealthy case: The residual R₁, as shown in FIG. 12C, can be implemented in Matlab. Naive attacks A₆ and A₇ are implemented without any system knowledge. The attacks A₆ and A₇ are waveforms with a period of 0.001 seconds and a phase delay of 10 seconds. The residual R₁ crosses the alarm threshold multiple times, indicating the presence of attacks as shown in FIG. 15B. While FIG. 15A shows the performance of residual during normal unattacked operating conditions. The attacker fails to implement a stealthy attack on the system. This simulation supports proposition 2 that the attacks on the overdetermined part of the system are attackable but also detectable with residuals.

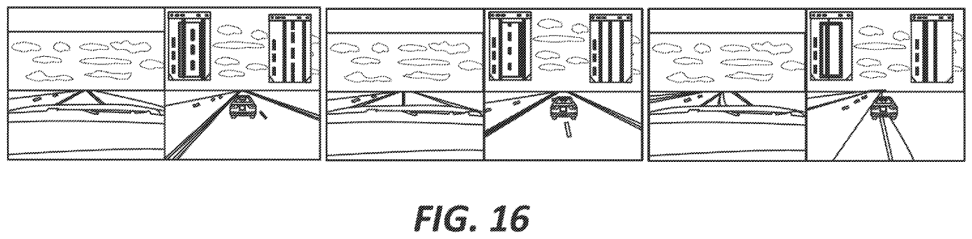

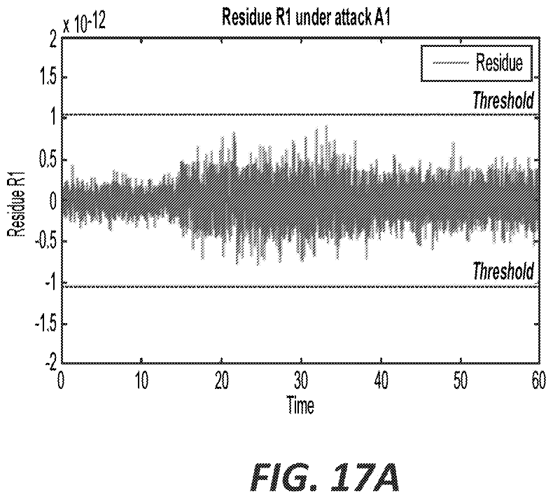

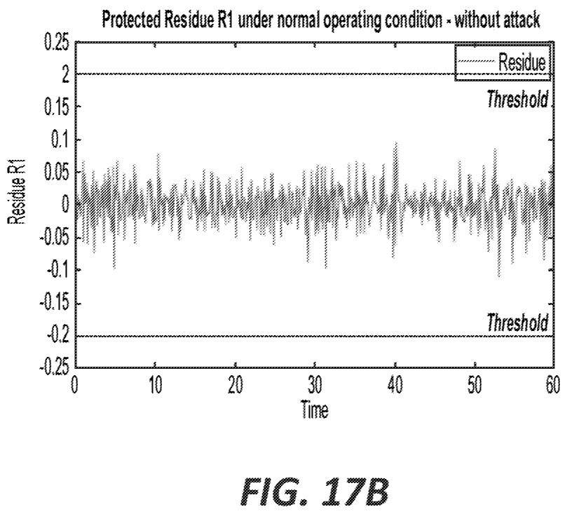

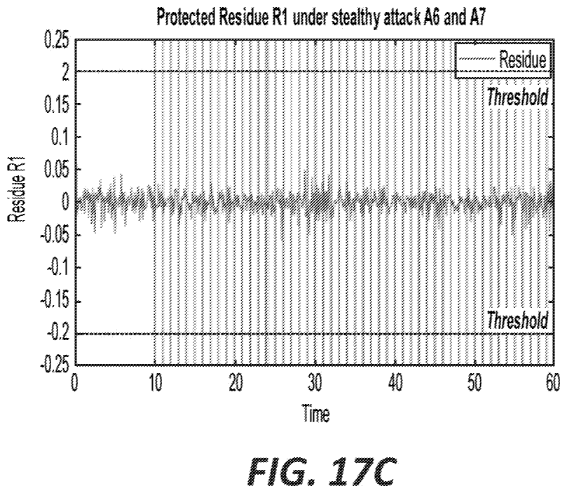

Actuator attack A₁ on just-determined part of the system: Attack A₁ is an actuator attack on the just-determined part of the system. As shown in proposition 1, residuals cannot be generated to detect the attack due to the lack of redundancy. Thus, the attack is stealthy and safety-critical on the system. The attack A₁ taking the vehicle out of the lane is shown in FIG. 16. Also, the attack does not trigger any other residuals in the system. The attack A₁ evaluated with residual R₁ is shown in FIG. 17A. This simulation supports proposition 1, that the attacks on the just determined part of the system are not detectable.

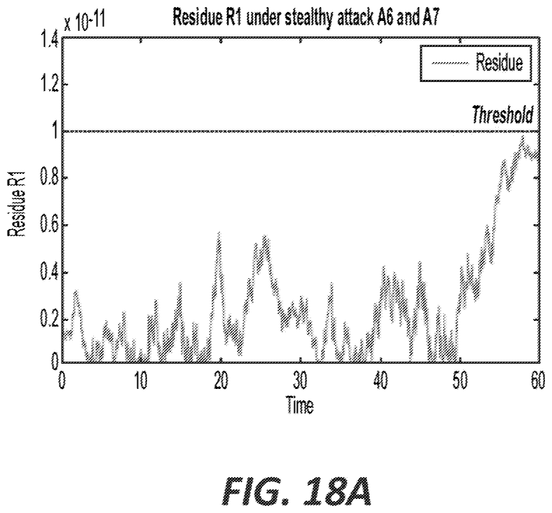

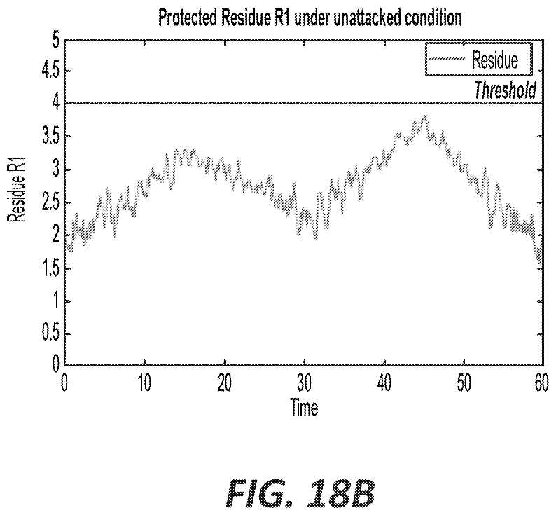

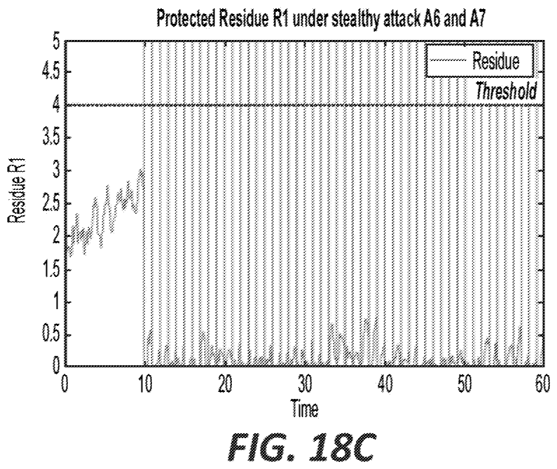

Stealthy attack vectors that attack the system but do not trigger the residual threshold: As shown in FIG. 15C, the attacker can implement a stealthy attack vector on the yaw rate and lateral acceleration sensor. In this case, the attacker has complete knowledge of the system and residual generation process. The attacker is capable of attacking the two branches in the sequential residual—FIG. 12C simultaneously. Hence, attacks the system with high amplitude, slow-changing (low frequency), disruptive, and safety-critical attack vectors. As shown in the example—FIG. 15C, the residual detection is completely compromised. This simulation again supports proposition 2, showing that an intelligent attacker could generate a stealthy attack vector to compromise the residual generation process. Since the residual (R₁) is compromised, the detection results are the same irrespective of the anomaly detector. Similar results can be seen with a CUSUM detector in FIG. 18A.

The study included an example case where no protected sensors were used (“case 1”). All the sensors defined in the attacker model in section V e1-e13 are vulnerable to attacks. From the DMD, it is evident that all other attacks can be detected and isolated except for attacks A₁ and A₃. For equations e1-e13, there are seven attack vectors, A₁, and A₃ gets assigned with higher weights. Even though the attacks could be detected with residuals, they do not have protected sensors as defined in Theorem 1. Thus, all the residuals could also be compromised and hence get assigned a higher weight. To derive the attack index as shown in equation 3, we need to assign the declared weights according to propositions 1 and 2. Thus,

$$α = \vert {\sum }_{j = 1}^{p} {( {W}^{a} )}_{i j} + {\sum }_{j = 1}^{{‖ R ‖}_{0}} {( {W}^{r} )}_{i j} \vert$$

$$α = ( 10 + 1 + 10 + 1 + 1 + 1 + 1 ) + ( 10 \times 10 ) = 25 + 100 = 125$$

As defined in assumption 1, an unprotected measurement is any sensor or actuator that can be attacked, and there exists a possibility of manipulating the value. In contrast, protected measurements cannot be attacked or manipulated. Protecting a measurement can be achieved in multiple ways, like cryptography or encryption, and is mostly application specific. The sensor and the actuator dynamics vary depending on the system and the manufacturer's configuration. Thus, there are multiple configurations of sensor suite in the ALC system that OEMs implement based on the space, computational power, market value of the vehicle, etc. An advantage of protecting a measurement is distinguishing between faults and attacks—a protected measurement can be faulty but cannot be attacked.

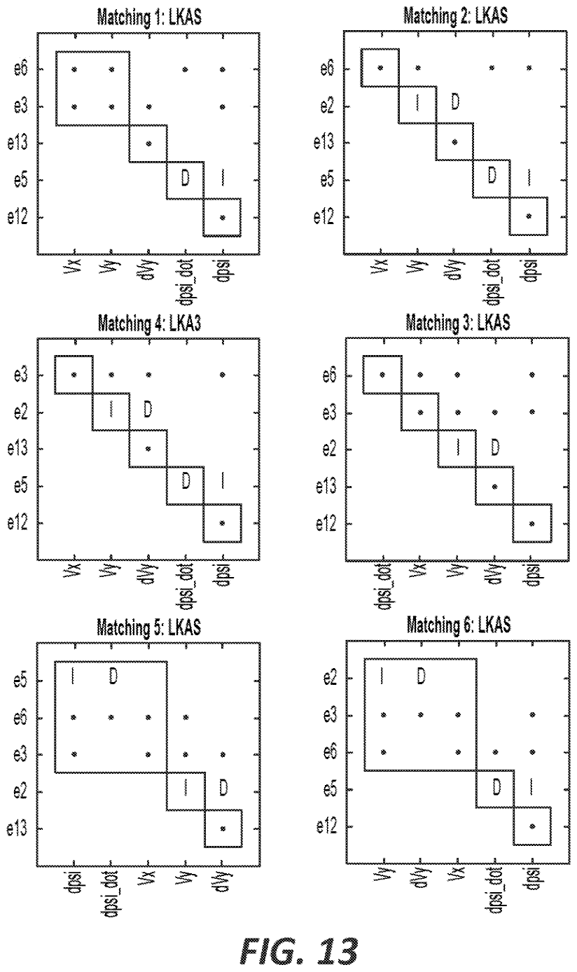

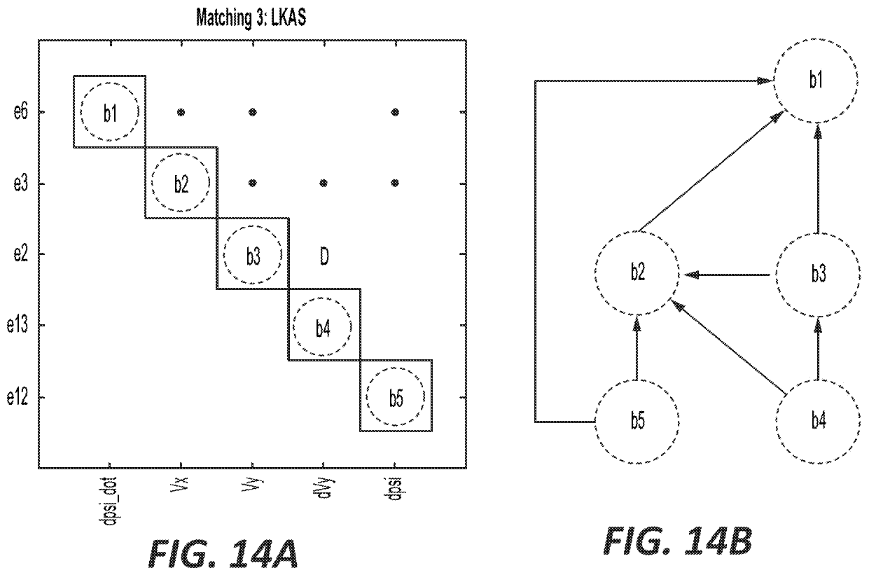

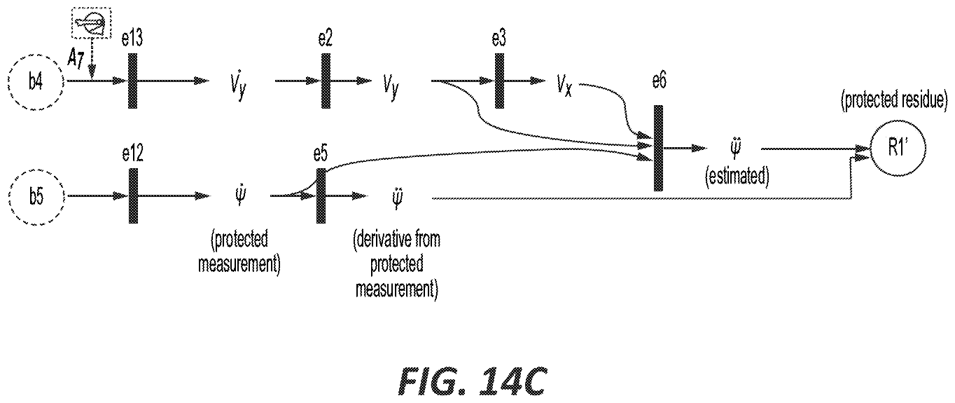

From the given sensor suite for the LKAS, this subsection discusses finding the optimal sensors to protect. From Theorem 1, for maximal security in attack detectability, it is required to protect the sensors of the highest block order for the given matching and use that protected sensor for a residual generation. The order of generation of the TES depends on the sensor placement. All the possible matching for TES-1 is shown in FIG. 13. Thus, the sensors that could be protected to increase the security index are vehicle velocity (Vₓ), vehicle lateral velocity (V_{y}), and change in yaw rate measurement (\ddot{ψ}). Since vehicle velocity is not a state in the LKAS, it is not the best candidate for applying protection mechanisms. Similarly, by comparing all other possible matchings from TES 1-10, the yaw rate measurement is the most optimal protected sensor because either the sensor or the derivative of the measurement occurs in the highest block order in most of the matching for TES 1-10. Also, the residual generated by estimating the state [\dot{ψ}] could be used to compare with the protected measurement. So, for TES-1, matching 3 is the best sensor placement strategy. An example computational sequence is given in FIGS. 14A-14C. Thus, the residual, say R₁′ generated with matching 3 and protected yaw rate measurement, is a protected residual. The stealthy attack A₆ and A₇ that was undetected with residual R1—FIG. 15C is detected using the protected residual R₁′ in FIG. 17C. FIG. 17B shows the residual under normal unattacked operating conditions. Thus, this simulation supports the claim in Theorem 1. Also, the protected residual R₁′ works irrespective of the detection strategy. Similar results to the Chi-squared detector are observed with the CUSUM detector in FIGS. 18B and 18C.

For case 2, let us assume that the yaw rate sensor is a protected measurement that cannot be attacked. The structural model remains the same as the sensor might still be susceptible to faults. Hence the attack vector (A₄) could be generalized as an anomaly than an attack. So, similar to case 1, the two attack vectors are in the just-determined part, and four attacks {A₂,A₅,A₆,A₇}(A₄ is not considered as an attack) in the over-determined part. Also, similar to case-1, 10 residuals can detect and isolate the attacks. Except for residual (R₇), all other residuals could be generated with a protected sensor or its derivative in the highest block order. Thus, we have nine protected residuals. Hence, the attack index from propositions 1,2, theorem 1, and the simulations shown in section VI-C, is calculated to be:

$$α = \vert {\sum }_{j = 1}^{p} {( {W}_{i}^{a} )}_{j} + {\sum }_{j = 1}^{{‖ R ‖}_{0}} {( {W}_{i}^{r} )}_{j} \vert$$

$$α = ( 10 + 10 + ( 1 \times 4 ) ) + ( ( 1 \times 9 ) + 10 ) = 43$$

The attack vectors are added to the system based on assumption 1. This is done by analyzing the behavioral model and using CAN DBC files to read the CAN for output measurements while manipulating the inputs to the system. The severity of the attacks is established by identifying the location of vulnerabilities in the system. With these potential attack vectors, we used the structural model to identify the safety-critical attacks and how hard it is to perform a stealthy implementation. From the structural model, it was identified that the attacks on the just-determined part are not detectable, while the attacks on the over-determined part are detectable due to redundancies in the system. Then, it was shown that even if the attacks are detectable with residuals, an intelligent attacker can inject stealthy attack vectors that do not trigger the residual threshold. Then, to improve the residual generation process and the security index of the system, the example implementation introduces protected sensors. The criterion for selecting a sensor to protect to minimize the attack index (maximize security index) was established. For a sequential residual generation process, it was shown that the residual generated with a protected sensor in the highest block order is more secure in attack detectability. In the LKAS example, the attack index with the specified weights without protected sensors is 125. Still, by just protecting one sensor, the attack index of the system was reduced to 43. The example implementation gives the system analyst freedom to choose the individual weights for the attacks and residuals. The weights can be chosen depending on the complexity of performing the attack using metrics like CVSS [35].

This example implementation of the present disclosure includes a novel attackability index for cyberphysical systems based on redundancy in the system and the computational sequence of residual generators. A non-linear dynamic model of an automotive system with CAN as the network interface was considered. The vulnerabilities in the system that are exploited due to improper network segmentation, open network components, and sensors were classified as unprotected measurements in the system. These unprotected measurements were modeled as attack vectors to the dynamic equations of the system. Then based on the sensor configurations and unknown variables in the system, the redundant and non-redundant parts were identified using canonical decomposition of the structural model. Then the attack index was derived based on the attack's location with respect to the redundant and non-redundant parts. Then with the concept of protected sensors, the residuals generated from the redundant part were analyzed on its computational sequence and placement strategy of the protected sensors. If there were no protected sensors, the sensor placement strategies for residuals and the optimal sensor(s) to protect were suggested to increase the system's security guarantees. Then MIL simulations were performed to illustrate the effectiveness of the example implementation.

### Example 3

A study was performed of an example implementation including vulnerability analysis of Highly Automated Vehicular Systems (HAVS) using a structural model. The analysis is performed based on the severity and detectability of attacks in the system. The study considers a grey box—an unknown nonlinear dynamic model of the system. The study deciphers the dependency of input-output constraints by analyzing the behavioral model developed by measuring the outputs while manipulating the inputs on the Controller Area Network (CAN). The example implementation can identify the vulnerabilities in the system that are exploited due to improper network segmentation (improper gateway implementation), open network components, and sensors and model them with the system dynamics as attack vectors. The example implementation can identify the redundant and non-redundant parts of the system based on the unknown variables and sensor configuration. The example implementation analyze the security implications based on the placement of the attack vectors with respect to the redundant and nonredundant parts using canonical decomposition of the structural model. Model-In-Loop (MIL) simulations verify and evaluate how the proposed analysis could be used to enhance automotive security.

The example implementation includes anomaly detectors constructed using redundancy in the system using qualitative properties of greybox structural models. This vulnerability analysis represents the system as a behavioral model and identifies the dependence of the inputs and outputs. Then based on the unknown variables in the model and the sensor placement strategy, redundancy in the system is determined. The potential vulnerabilities are then represented as attack vectors with respect to the system. If the attack vector lies on the redundant part, detection and isolation are possible with residuals. If not, the attack remains stealthy and causes maximum damage to the system's performance. Thus, this work proposes a method to identify and visualize vulnerabilities and attack vectors with respect to the system model. The MIL-simulation results show the impact of attacks on the Lane Keep Assist System (LKAS) identified using the proposed approach.

FIG. 3 illustrates an example system model that can be used with a network layer to transmit sensor messages and control plant actuation. An attacker can compromise the system either by attacking the CAN to inject falsified sensor or actuator messages or by performing adversarial attacks on the sensors.

The system model can include a grey-box system that describes nonlinear dynamics:

\dot{x}(t)=ƒ(x(t),θ)+g(x(t),θ)u(t)

y(t)=h(x(t),θ)

where x∈ [symbol] ⁿ is the state vector, u∈ [symbol] ^{q} is the control input, y∈ [symbol] ^{m} is the sensor measurement, and θ is the set of unknown model parameters. Based on [13B], and [14B], let us assume that the nonlinear system is uniformly observable—the functions ƒ, g, and h are smooth and invertible. Also, the parameter set θ exists such that model defines the system. Under a special case (when the model is well-defined), the linearized—Linear Time-Invariant (LTI) version of the plant is given by ƒ(x(t))+g(x(t))u(t)=Axₜ+Buₜ and yₜ=Cxₜ where A∈ [symbol] ^{n×n}, B∈ [symbol] ^{n×q}, and C∈ [symbol] ^{m×n} are the system, input, and output matrices respectively.

The model parameters θ and the functions ƒ, g, and h are unknown it can be assume that the implementation knows the existence of parameters and states in the functions, hence a grey-box approach.

The attacker model is given by:

u^{c}(t)=u(t)+aₐ(t)

y^{c}(t)=y(t)+aₛ(t)

where aₐ(t)∈ [symbol] ^{p}^{₁} and aₛ(t)∈ [symbol] ^{p}^{₂} are the actuator and sensor attack vectors (p₁+p₂=p). The compromised state of the system at time t can be linearized as \dot{x}ᵢ^{c}(t)=ΣAᵢⱼxⱼ(t)+Σⱼ₌₁ⁿ[Bᵢⱼuⱼ(t)+B_{a,ij}a_{a,j}(t)]. Where uᵢ^{c}(t)=B_{a,ij}a_{a,j}(t) is the actuator attack signal injected by the attacker. Similarly, yᵢ^{c}(t)=Σⱼ₌₁ⁿCᵢⱼxⱼ(t)+C_{s,ij}a_{s,j}(t) is a compromised sensor measurement and a_{s,i}(t) in the attack injected. u′(t)∈ [symbol] ^{q-p}^{₁} and y′(t)∈ [symbol] ^{m-p}^{₂} are the actuator and sensor signals that have not been compromised due to the attack.

The structural model of the system analyzes the qualitative properties of the system to identify the analytically redundant part [12B]. The non-zero elements of the system are called the free parameters, and they are of main interest in the present study. Note that the exact relationship of the free parameters is not required; just the knowledge of their existence is sufficient. Furthermore, let the study assumes that the input and measured output are known precisely. Thus, with the free parameters, the system's structure can be represented by a bipartite graph G=(V∪E, Γ) where V={x₁, x₂, . . . , xₙ, y₁, y₂, . . . , yₘ, u₁, u₂, . . . , u_{q}, a₁, a₂, . . . , aₚ} are the set of nodes corresponding to the state, measurements, input, and attack vectors. These variables can be classified into known Z⊂V and unknowns X⊂V. The bipartite graph can also be represented by a weighted graph where the weight of each edge corresponds to [A: B, Bₐ: C, Cₐ]. The relationship of these variables in the system is represented by the set of equations (or constraints) E={e₁, e₂, . . . , eᵣ}. Γ={(eᵢ,vⱼ)|vⱼ in eᵢ,vⱼ∈V,i∈[1, 2, . . . , r], j∈[1, 2, . . . , n+m+q]} is an edge which links the equation eᵢ to variable vⱼ. The matrix form of the bipartite graph can be represented as an adjacency matrix M (Structural Matrix), a Boolean matrix with rows corresponding to E and columns to V and M={m_{i,j}|m_{i,j}=1 if (eᵢ, vⱼ)∈Γ, 0 otherwise}. In the above definition, the differentiated variables are structurally different from the integrated variables.

Definition 1: (Matching) Matching on a structural model M is a subset of Γ such that two projections of any edges in M are injective. This indicates that any two edges in G do not share a common node. A matching is maximal if it contains the largest number of edges (maximum cardinality) and perfect if all the vertices are matched. Matching can be used to find the causal interpretation of the model and the Analytically Redundant Relations (ARR)—the relation E that is not involved in the complete matching.

The motive of structural analysis is to identify matchings in the system. If an unknown variable is matched with a constraint, then it can be calculated from the constraint. If they can be matched in multiple ways, they contribute to redundancy that can be potentially used for abnormality detection. Based on the redundancy, the system can be divided into three sub-models: under-determined (no. of unknown variables>no. of constraints), just-determined (no. of unknown variables=no. of constraints), and over-determined part (no. of unknown variables<no. of constraints). An alternate way of representing the adjacency matrix is Dulmage-Mendelsohn's (DM) decomposition (DMD) [15B]. DMD is obtained by rearranging the adjacency matrix in block triangular form and is a better way to visualize the categorized sub-models in the system. The under-determined part of the model is represented by G⁻ with node sets E⁻, and V⁻ the just-determined or the observable part is represented by G⁰ with node sets E⁰ and V⁰. The over-determined part (also observable) is represented by G⁺ with node sets E⁺ and V⁺. Attack vectors in the under-determined (a⁻) and just-determined (a⁰) part of the system are not detectable. While Attack vectors in the overdetermined (a⁺) part of the system are detectable with the help of redundancies.

Consider the system and attacks as shown in (1) and (2). From the G⁺ part of the DMD, residuals can be generated using the unmatched redundant constraints and can be checked for consistency. The structure of the residual is the set of constraints—monitorable sub-graphs with which they are constructed. The monitorable subgraphs are identified by finding the Minimal Structurally Overdetermined (MSO) set as defined in [16B].

Definition 2: (Proper Structurally Overdetermined (PSO)) A non-empty set of equations E≠Ø is PSO if E=E⁺.

The PSO set is the testable subsystem, which may contain smaller subsystems—MSO sets.

### Definition 3: (Minimal Structurally Overdetermined (MSO))

A PSO set is MSO set if no proper subset is a PSO set.

MSO sets are used to find the minimal testable and monitorable subgraph in a system.

Definition 4: Degree of structural redundancy is given by φ(E)=|E⁺|−|X⁺|

Lemma 1: If E is a PSO set of equations with e∈E, then φ(E\{e})≥φ(E)−1.

Lemma 2: The set of equations E is an MSO set if and only if E is a PSO set and φ(E)=1

The proof Lemma 1 and Lemma 2 is given in [16B] by using Euler's totient function definition [17B].

For each MSO set identified according to Lemma 2, a set of equations called the Test Equation Support (TES) can be formed to test for faults or attacks. A TES is minimal (MTES) if there exist no subsets that are TES. Thus, MTES leads to the most optimal number of sequential residuals by eliminating unknown variables from the set of equations (parity-space-like approaches).

Definition 5: (Residual Generator) A scalar variable R generated only from known variables (z) in the model M is the residual generator. The anomaly detector looks if the scalar value of the residual (usually a normalized value of residue Rₜ) is within the threshold limits under normal operating conditions. Ideally, it should satisfy lim_{t→∞}R(z)=0

An MTES set might involve multiple sensor measurements and known parameters in the residual generation process. The generated residue is actively monitored using a statistical anomaly detector.

A system defined in (1) is vulnerable if there exists an attack vector that lies in the structurally under or just-determined part. The consequence of the attack is severe if there is a significant deviation of the state from its normal operating range. Ideally, lim_{t→∞}∥Δx(t)∥=∞ is the unbounded condition for the attack sequence.

Thus, the example implementation can analyze a given system to identify vulnerabilities that could potentially be exploited into attacks. The impact of the attacks is derived from the DM decomposition of the system, and the complexity of performing the attacks is based on the implementation of anomaly detectors (if any). The attacks on the under and just determined part of the system are not detectable and have severe consequences.

The study of the example implementation included performing vulnerability analysis on structured grey-box control systems. The under-determined part of the system is not attackable as the nodes are not reachable but still susceptible to faults. A vertex is said to be reachable if there exists at least a just-determined subgraph of G that has an invertible edge (eᵢ, xⱼ).

Proposition 1: The system is most vulnerable if the measurements on the just-determined part can be compromised.

Proof: This is due to the presence of undetectable attack vectors from the sensors and actuators. The attack vector aᵢ is not detectable due to the lack of residues. From definitions 3, 4, lemma 1, and 2:

E⁰∉MSO⇒φ(E⁰)=0.

Hence residual generation (formation of TES) is not directly possible on E⁰, and any attack is not detectable.

Anomaly detection on the just-determined part is only possible if redundancy in the form of additional sensors or prediction and estimation strategies is added to the system. The over-determined part of the system is attackable, but the attacks are detectable from the residues generated from MTES. To have an undetectable attack, the attack vector should satisfy the stealthy condition—the attack vector should be within the threshold limits of the anomaly detector. Thus, the complexity of performing a successful attack is high, which leads to proposition 2.

Proposition 2: The over-determined part of the system with vulnerable sensors and actuators is more secure as residues can be designed to detect attacks.

The system is attackable if it has vulnerable sensors and actuators. However, to perform a stealthy attack, the attacker should inject attack vectors that should be within the threshold limits of the anomaly detector. Hence, here we show the condition for detectability and the existence of residues. Let us consider the transfer function representation of the general model: y=G(s)u+A(s)a. Thus, an attack is detectable if

Rank[G(s)A(s)]>Rank[G(s)]

This satisfies the condition [18B] [19B] that there exists a transfer function Q(s) such that residue

r=Q(s)[y^{T}u^{T}]^{T}

The residues capable of detecting the attack are selected from the MTES that satisfy the above criterion. Proposition 2 shows that vulnerable measurements in the system could lead to attacks. However, these attacks are detectable with residues, making the system overall less vulnerable.

The vulnerability analysis is based on the structural model of the system. The structural matrices are qualitative properties and do not always consider the actual dynamical equations of the system. Thus, the analysis can be performed even with a realization of the system and not necessarily with exact system parameters.

Thus, following the definition from C.1 [20B] and [21B], Theorem 1 can be formulated as:

Theorem 1: The vulnerability analysis is generic and remains the same for any choice of free parameters (θ) in the system.

Proof: For the scope of this proof, assume a linearized version of the system (1). Let H(s)∈R^{m×q} be a transfer function matrix. Here we only know the structure of the polynomial matrix, the coefficients of the matrix are unknown. Let the generic-rank (g-rank) of the transfer function grank (H)=K. From [22B], g-rank (H) is the maximum matching in the bipartite graph G constructed from the polynomial matrix. For a given maximum matching, the bipartite graph G can be decomposed as under (V⁻, E⁻), just (V⁰, E⁰) and over-determined (V⁺, E⁺).

For the under-determined part (|E⁻|>0), the subgraph G-contains at least two maximum matching of order |E-land the sets of initial vertices do not coincide. The rank H_{V}_{^{−}}_{E}_{^{−}}(s)=|E⁻|⇒full row rank.

For the just-determined part (|E⁰|=|V⁰|>0), the subgraph G⁰ contains at least one maximum matching of order |E⁰|=|V⁰|. The rank H_{V}_{⁰}_{E}_{⁰}(s)=|E⁰|=|V⁰|⇒H_{V}_{⁰}_{E}_{⁰} is invertible.

For the over-determined part (|V⁺|>0), the subgraph G⁺ contains at least two maximum matching of order |V⁺| and the sets of initial vertices do not coincide. The rank H_{V}_{⁺}_{E}_{⁺}(s)=|V⁺|⇒full column rank.

The DM decomposition of H is given by:

$$[ \begin{matrix}{H}_{{E}^{-} {V}^{-}} ( s ) & {H}_{{E}^{-} {V}^{0}} ( s ) & {H}_{{E}^{-} {V}^{+}} ( s ) \\ 0 & {H}_{{E}^{0} {V}^{0}} ( s ) & {H}_{{E}^{0} {V}^{+}} ( s ) \\ 0 & 0 & {H}_{{E}^{+} {V}^{+}} ( s )\end{matrix} ]$$

Hence, Theorem 1 shows that DMD can be computed with just the input-out relation of the system (transfer function polynomial matrix). Thus, for any choice of free parameters in system realization, the vulnerability analysis performed using the structural model is generic. A qualitative property thus holds for all systems with the same structure and sign pattern. The structural analysis concerns zero and non-zero elements in the parameters and not their exact values.

The input-out relation for automotive systems can be obtained by varying the input parameters and measuring the output through CAN messages, and decoding them with CAN Database (DBC). This way, the example implementation can decipher which output measurements vary for different input parameters.

The study shows that the example implementation can perform vulnerability analysis on a real-world system. The study includes an Automated Lane Centering System (ALC). A grey-box model of the lane keep assist system with vehicle dynamics, steering dynamics, and the communication network (CAN). Despite knowing the precise dynamics of LKAS [23B] [24B], the study considers the system as a grey box, and the input-out relation of the grey-box model was additionally verified on an actual vehicle.

The system model, as shown in FIG. 9 uses an LKA controller (typically a Model Predictive Controller (MPC) [24B] or Proportional-Integral-Derivative (PID) controller [25B]) to actuate a DC motor connected to the steering column to steer the vehicle to the lane center. The LKAS module has three subsystems: (i) the steering system—steering column [e1-e4], steering rack [e8-e10], (ii) the power assist system [e5-e7], and (iii) the vehicle's lateral dynamics control system [e11e16]. The LKAS is implemented on an Electronic Control Unit (ECU) with a set of sensors to measure the steering torque, steering angle, vehicle lateral deviation, lateral acceleration, yaw rate, and vehicle speed. The general mechanical arrangement of LKAS and the dynamical vehicle model is the same as considered in [23B]. The dynamic equations of the LKAS module without driver inputs are given by:

\dot{θ}_{c}(t)=ω_{c}(t) e1:

$$\frac{d {ω}_{c}}{dt} = {\dot{ω}}_{c} ( t ) \qquad e 2$$

Tₛₑₙ(t)=ƒ₁(θ_{c},xᵣ) e3:

\dot{ω}_{c}(t)=ƒ₂(Tₛₑₙ,ω_{c}) e4:

\dot{θ}ₘ(t)=ωₘ(t) e5:

$$\frac{d {ω}_{m}}{d t} = {\dot{ω}}_{m} ( t ) \qquad e 6$$

\dot{ω}ₘ(t)=ƒ₃(Tₘ,θₘ,xᵣ,ωₘ) e7:

\dot{x}ᵣ(t)=vᵣ(t) e8:

$$\frac{d {v}_{r}}{dt} = {\dot{v}}_{r} ( t ) \qquad e 9$$

\dot{v}ᵣ(t)=ƒ₄(Tₛₑₙ,θₘ,xᵣ,vᵣ,δ,Vₓ,γ) e10:

\dot{Y}_{y}(t)=V_{y}(t) e11:

$$\frac{{dV}_{y}}{dt} = {\dot{V}}_{y} \qquad e 12$$

\dot{V}_{y}=ƒ₅(V_{y},Vₓ,\dot{γ},γ_{des},δ) e13:

$$\frac{d γ}{dt} = \dot{γ} \qquad e 14$$

$$\frac{{d}^{2} γ}{{dt}^{2}} = \ddot{γ} \qquad e 15$$

\ddot{γ}=ƒ₆(V_{y},Vₓ,\dot{γ},δ,γ_{des}) e16:

Y_{L}=Y_{y}+(γ)×LAD e17:

The state vectors of the system are given by x=[θ_{c} ω_{c} θₘ ωₘ xᵣ vᵣ Y_{y} V_{y} γ \dot{γ}]^{T}. The input to the power steering module is the motor torque from the controller, and the output is the lateral deviation Y_{L}. \dot{γ}_{des} is the desired yaw rate given as disturbance input to avoid sudden maneuvers to enhance the user's comfort.

The optimal control action to steer the vehicle back to the lane center is given by solving the quadratic optimization problem given in e18. Equation e19 (motor actuator) is the required torque calculated by the controller that is applied on the motor.

$${\sum }_{i = 1}^{N - 1} {‖ {Y}_{{Y}_{y}} ( i \vert k ) - {Y}_{R} ( i \vert k ) ‖}_{2}^{Q} + {‖ {Y}_{δ} - δ ‖}_{2}^{R} \qquad e 18$$

τ_{req}=ƒ₇(δ)+A₁ e19:

The sensor suite for the LKAS module is given by:

Y_{Y}_{_{y}}=Y_{y}+(A₂) e20:

Y_{R}=R+(A₃) e21:

Y_{θ}_{_{c}}=θ_{c}+(A₄) e22:

Y_{Tsen}=Tₛₑₙ+(A₅) e23:

Y_{Tm}=Tₘ+(A₆) e24:

Y_{δ}=δ+(A₇) e25:

Y_{V}_{ₓ}=Vₓ+(A₈) e26:

Y_{\dot{γ}}=\dot{γ}+(A₉) e27:

Y_{\dot{V}}_{_{y}}=\dot{V}_{y}+(A₁₀) e28:

The steering wheel torque (e23), wheel speed (e26), yaw rate (e27), and lateral acceleration (e28) sensors have been mandated by National Highway Traffic Safety Administration (NHTSA) for passenger vehicles since 2012 [26B].

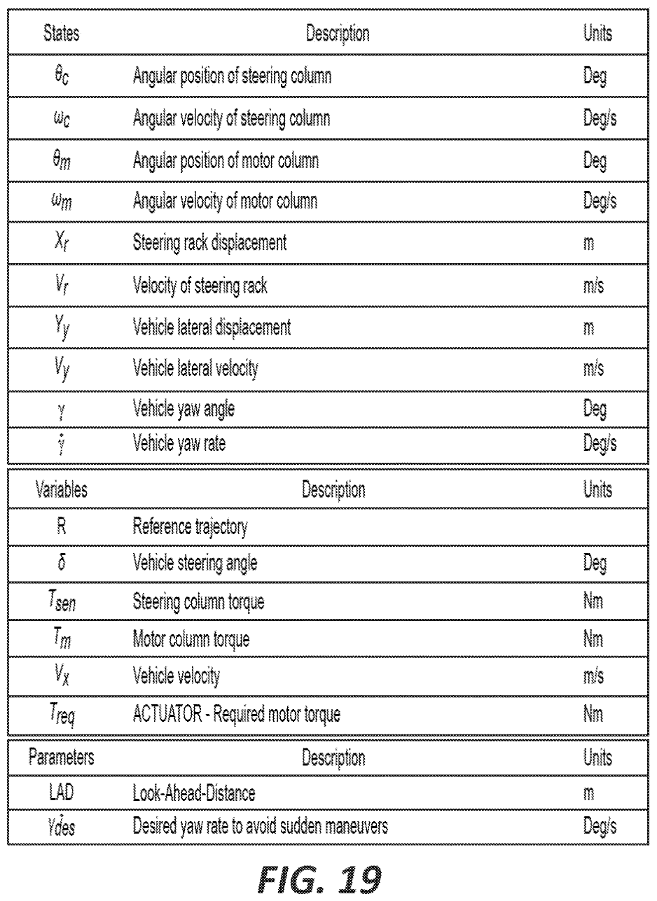

FIG. 19 illustrates a table of variable parameters of an example lane keep assist system, used in the study of the example implementation.

The study identifies the vulnerable measurements in the system by analyzing the CAN DBC files [27B]. Hence an attack vector Aᵢ is added to the dynamic equation of the vulnerable measurement—all the measurements visible on the CAN that the LKA controller uses to compute steering torque. Also, the redundancy in the messages published on CAN is not accounted as ARR. The sensor and the actuator dynamics vary depending on the device and the manufacturer's configuration. There are multiple configurations of the sensor suite in the ALC system that OEMs implement based on the space, computational power, and market value of the vehicle. The vulnerability analysis of LKAS across different OEMs can be similar as long the input-output relations and system structure are similar.

The LKAS calculates the required steering angle based on the sensor values on CAN, determines the required torque to be applied by the motor, and publishes the value on the CAN. The motor controller then actuates the motor to apply the required torque to keep the vehicle in the center of the lane. Thus, the actuator attack A₁ manipulates the required torque, and incorrectly applied torque drives the vehicle away from the lane center. e20-e28 are sensor dynamics where A₂-A₁₀ are the sensor attacks. Attacks A₂ and A₃ are physical-world adversarial attacks on perception sensors for lane detection as shown in [28B]. Other attacks are implemented by attacking and compromising the CAN.

The first step in analyzing the structural model of the system is to identify the known and unknown parameters (variables) in the system. The unknown (X⊂V) are the quantities that are not measured. Hence from e1-e28, it is clear that the state vector X and the set {Tₛₑₙ, Tₘ, δ, Vₓ, T_{req}, R,} are the unknown parameters. While the measurements from the sensors are the known and measured parameters {Y_{Tsen}, Y_{Tm}, Y_{δ}, Y_{V}, Y_{Y}_{_{y}}, Y_{R}, Y_{δ}, Y_{\dot{V}}_{_{y}}, Y_{θ}_{ₛ}}. Note that the parameter is unknown until it is measured using the sensor.

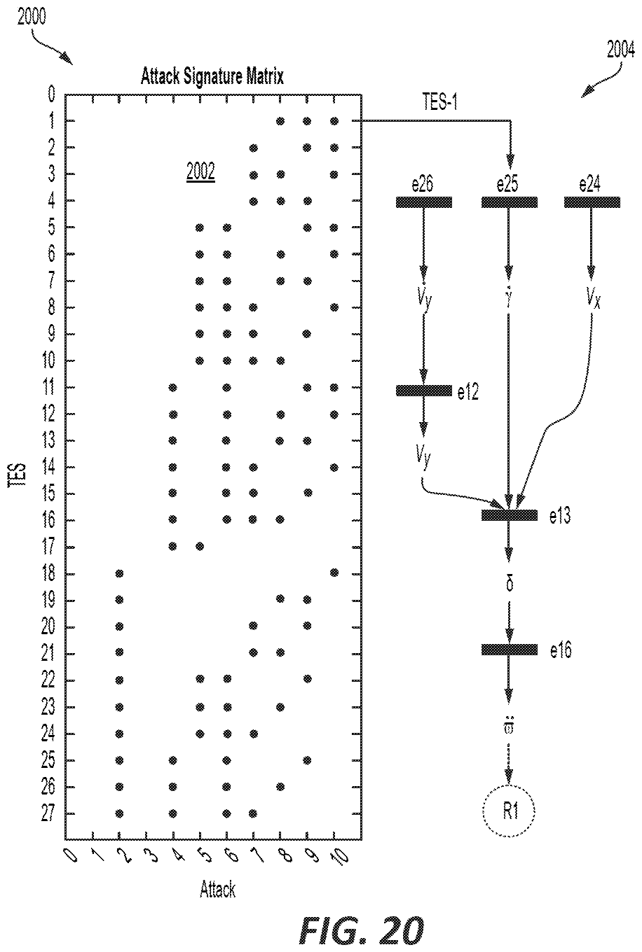

For example, Tₛₑₙ is unknown while Y_{Tsen} from the torque sensor is known. The DM Decomposition of the LKAS is given in FIG. 10B. The dot in the DMD implies that the variable on X-axis is related to the equation on Y-axis. Thus, from the DM decomposition, it is evident that the attacks A₁ and A₃ in the just-determined part are not detectable and other attacks on the over-determined part are detectable. The greyshaded part of the DMD in FIG. 10B denotes the equivalence class, and the attacks in different equivalence classes can be isolated from each other with test equations (residues). The attacks A₂, A₄-A₁₀ are detectable and isolable. The residues generated (TES) that can detect and isolate the attacks are given by the attack signature matrix 2000 in FIG. 20. The dots 2002 in the attack signature matrix 2000 represents the attacks in the X axis that the TES in Y-axis can detect. For example, the TES-1 (Residue-1) can detect attacks 8, 9, and 10.

The LKAS is simulated in Matlab and Simulink to perform vulnerability analysis. The simulated system very closely resembles the LKAS from an actual vehicle. The attacks are injected on the sensors/actuators in the simulated environment, and residues were designed using the structural model of the system. For the scope of this paper, only residual plots and analysis of TES-1 (R₁) are shown. However, the analysis remains the same for all TES (TES 1-27) shown in FIG. 20.

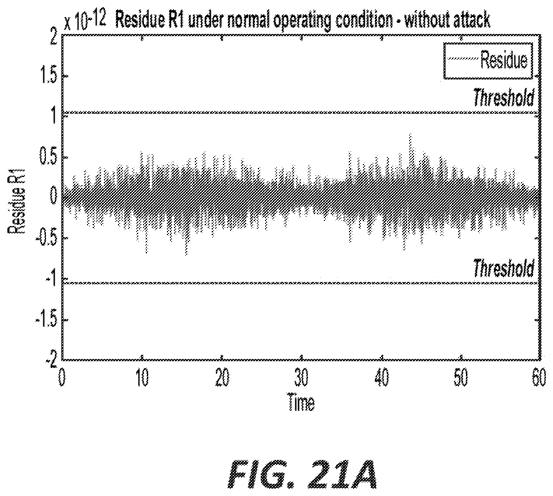

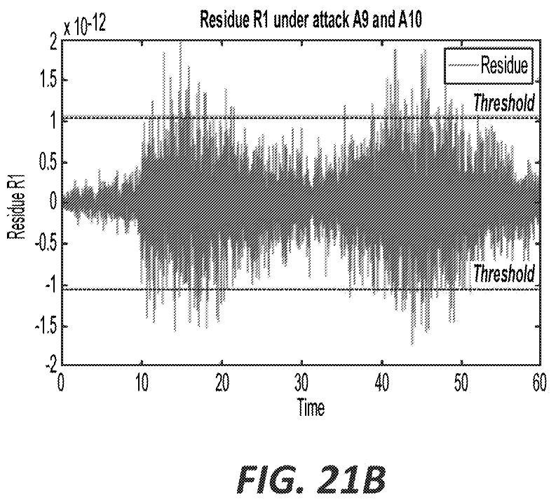

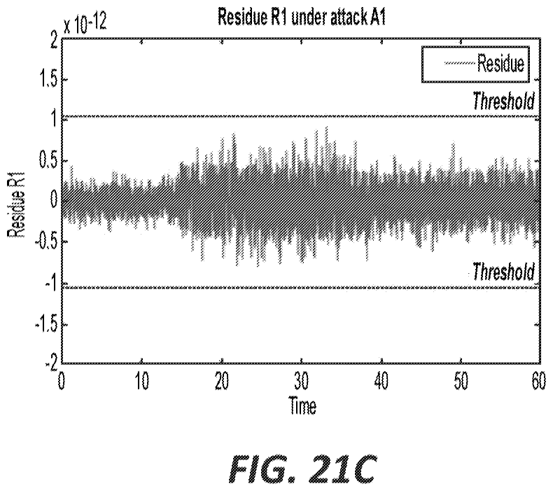

The computation sequence 2004 for TES-1 is shown in FIG. 20 The simulations support propositions 1 and 2: FIG. 21A shows the implementation of residue R₁ (TES-1) in the structurally over-determined part under normal unattacked operation. FIG. 21B shows the working of residue R₁ under attacks A₉ and A₁₀. It is evident that the residue crosses the threshold multiple times. This could trigger an alarm to alert the vehicle user. FIG. 16 shows the implementation of attack A₁ in the simulation environment. FIG. 21C shows that the attack A₁ lies in the just determined part, and existing residues fail to detect the attack. Thus, the attacks A₁ and A₃ [28B] on the just-determined part make the system extremely vulnerable, and the attack remains undetected, causing adverse safety violations. The attacks A₂, A₄-A₁₀ are still possible but much harder to implement stealthily due to the presence of residues.

The study of the example implementation includes vulnerability analysis using the structural model of a grey-box (unknown nonlinear plant dynamics) HAV system. The example implementation establishes the severity of the attacks by identifying the location of vulnerability in the system. The example implementation can analyze the behavioral model and using CAN DBC files to read the CAN for output measurements while manipulating the inputs to the system. The study categorized the variables and measurements as redundant (over-determined) and non-redundant (just-determined) parts and claim that attacks on the over-determined part can be detected and isolated. In contrast, attacks on the just-determined part may not be detected without external observers. Thus, the example implementation can determine how vulnerable the overall system is by quantitative measurement of the attacks that fall in the just and over-determined parts. Security guarantees can be established by moving the measurements from the just-determined to the over-determined part by adding redundancy in the form of additional sensors or nonlinear state estimators.

The following patents, applications, and publications, as listed below and throughout this document, describes various application and systems that could be used in combination the exemplary system and are hereby incorporated by reference in their entirety herein.
[1] M. Blanke, M. Staroswiecki, and N. Wu, “Concepts and methods in fault-tolerant control,” in Proceedings of the 2001 American Control Conference. (Cat. No. 01CH37148), vol. 4, 2001, pp. 2606-2620 vol. 4.
[2] D. Düştegör, E. Frisk, V. Cocquempot, M. Krysander, and M. Staroswiecki, “Structural analysis of fault isolability in the damadics benchmark,” Control Engineering Practice, 2006.
[3] J. Milošević, H. Sandberg, and K. H. Johansson, “A security index for actuators based on perfect undetectability: Properties and approximation,” in 2018 56th Annual Allerton Conference on Communication, Control, and Computing (Allerton), 2018, pp. 235-241.
[4] A. Khazraei, S. Hallyburton, Q. Gao, Y. Wang, and M. Pajic, “Learning-based vulnerability analysis of cyber-physical systems,” in 2022 ACM/IEEE 13th International Conference on Cyber-Physical Systems (ICCPS). IEEE, 2022, pp. 259-269.
[5] H. Cam, P. Mouallem, Y. Mo, B. Sinopoli, and B. Nkrumah, “Modeling impact of attacks, recovery, and attackability conditions for situational awareness,” in IEEE International Inter-Disciplinary Conference on CogSIMA, 2014.
[6] A. L. Dulmage and N. S. Mendelsohn, “Coverings of bipartite graphs,” Canadian Journal of Mathematics, vol. 10, pp. 517-534, 1958.
[7] M. Zhang, P. Parsch, H. Hoffmann, and A. Masrur, “Analyzing can's timing under periodically authenticated encryption,” in 2022 Design, Automation & Test in Europe Conference & Exhibition (DATE). IEEE, 2022, pp. 620-623.
[8] M. Krysander, J. Aslund, and M. Nyberg, “An efficient algorithm for finding minimal overconstrained subsystems for model-based diagnosis,” IEEE Transactions on Systems, Man, and Cybernetics-Part A: Systems and Humans, vol. 38, no. 1, pp. 197-206, 2007.
[9] D. Lehmer, “On euler's totient function,” Bulletin of the American Mathematical Society, vol. 38, no. 10, pp. 745-751, 1932.
[10] T. Sato, J. Shen, N. Wang, Y. Jia, X. Lin, and Q. A. Chen, “Dirty road can attack: Security of deep learning based automated lane centering under Physical-World attack,” in 30th USENIX Security Symposium (USENIX Security 21), 2021.
[11] Z. El-Rewini, K. Sadatsharan, D. F. Selvaraj, S. J. Plathottam, and P. Ranganathan, “Cybersecurity challenges in vehicular communications,” Vehicular Communications, 2020.
[12] M. Nyberg and E. Frisk, “Residual generation for fault diagnosis of systems described by linear differential-algebraic equations,” IEEE Transactions on Automatic Control, vol. 51, no. 12, pp. 1995-2000, 2006.
[13] M. Nyberg, “Criterions for detectability and strong detectability of faults in linear systems,” IFAC Proceedings Volumes, vol. 33, no. 11, pp. 617-622, 2000.
[14] S. Sundaram, “Fault-tolerant and secure control systems,” University of Waterloo, Lecture Notes, 2012.
[15] S. Gracy, J. Milošević, and H. Sandberg, “Actuator security index for structured systems,” in 2020 American Control Conference (ACC). IEEE, 2020, pp. 2993-2998.
[16] J. Van der Woude, “The generic dimension of a minimal realization of an ar system,” Mathematics of Control, Signals and Systems, vol. 8, no. 1, pp. 50-64, 1995.
[17] S. Kamat, IFAC-PapersOnLine, vol. 53, no. 1, pp. 176-182, 2020.
[18] R. Marino, S. Scalzi, G. Orlando, and M. Netto, “A nested pid steering control for lane keeping in vision based autonomous vehicles,” in 2009 American Control Conference. IEEE, 2009, pp. 2885-2890.
[19] X. Li, X.-P. Zhao, and J. Chen, “Controller design for electric power steering system using ts fuzzy model approach,” International Journal of Automation and Computing, vol. 6, no. 2, pp. 198-203, 2009.
[20] Commaai, “Opendbc.” [Online]. Available: https://github.com/commaai/opendbc
[1A] A. Greenberg, “Hackers remotely kill a jeep on the highway—with me in it,” Wired, vol. 7, no. 2, pp. 21-22, 2015.
[2A] S. Checkoway, D. McCoy, B. Kantor, D. Anderson, H. Shacham, S. Savage, K. Koscher, A. Czeskis, F. Roesner, and T. Kohno, “Comprehensive experimental analyses of automotive attack surfaces,” in 20th USENIX security symposium (USENIX Security 11), 2011.
[3A] V. Renganathan, E. Yurtsever, Q. Ahmed, and A. Yener, “Valet attack on privacy: a cybersecurity threat in automotive bluetooth infotainment systems,” Cybersecurity, vol. 5, no. 1, pp. 1-16, 2022.
[4A] Y.-C. Chang, L.-R. Huang, H.-C. Liu, C.-J. Yang, and C.-T. Chiu, “Assessing automotive functional safety microprocessor with iso 26262 hardware requirements,” in Technical papers of 2014 international symposium on VLSI design, automation and test. IEEE, 2014, pp. 1-4.
[5A] M. Blanke, M. Staroswiecki, and N. Wu, “Concepts and methods in fault-tolerant control,” in Proceedings of the 2001 American Control Conference. (Cat. No. 01CH37148), vol. 4, 2001, pp. 2606-2620 vol. 4.
[6A] D. Düştegör, E. Frisk, V. Cocquempot, M. Krysander, and M. Staroswiecki, “Structural analysis of fault isolability in the damadics benchmark,” Control Engineering Practice, 2006.
[7A] J. Milošević, H. Sandberg, and K. H. Johansson, “A security index for actuators based on perfect undetectability: Properties and approximation,” in 2018 56th Annual Allerton Conference on Communication, Control, and Computing (Allerton), 2018, pp. 235-241.
[8A] A. Khazraei, S. Hallyburton, Q. Gao, Y. Wang, and M. Pajic, “Learning-based vulnerability analysis of cyber-physical systems,” in 2022 ACM/IEEE 13th International Conference on Cyber-Physical Systems (ICCPS). IEEE, 2022, pp. 259-269. [9] S. M. Dibaji, M. Pirani, D. B. Flamholz, A. M. Annaswamy, K. H. Johansson, and A. Chakrabortty, “A systems and control perspective of cps security,” Annual reviews in control, vol. 47, pp. 394-411, 2019.
[10A] S. Weerakkody, X. Liu, S. H. Son, and B. Sinopoli, “A graph-theoretic characterization of perfect attackability for secure design of distributed control systems,” IEEE Transactions on Control of Network Systems, vol. 4, no. 1, pp. 60-70, 2016.
[11A] J. Milošević, A. Teixeira, K. H. Johansson, and H. Sandberg, “Actuator security indices based on perfect undetectability: Computation, robustness, and sensor placement,” IEEE Transactions on Automatic Control, vol. 65, no. 9, pp. 3816-3831, 2020.
[12A] S. Gracy, J. Milošević, and H. Sandberg, “Security index based on perfectly undetectable attacks: Graph-theoretic conditions,” Automatica, vol. 134, p. 109925, 2021.
[13A] K. Zhang, C. Keliris, M. M. Polycarpou, and T. Parisini, “Detecting stealthy integrity attacks in a class of nonlinear cyber-physical systems: A backward-in-time approach,” Automatica, vol. 141, p. 110262, 2022.
[14A] Y. Mo and B. Sinopoli, “Secure control against replay attacks,” in 2009 47th annual Allerton conference on communication, control, and computing (Allerton). IEEE, 2009, pp. 911-918.
[15A] A. Teixeira, I. Shames, H. Sandberg, and K. H. Johansson, “Revealing stealthy attacks in control systems,” in 2012 50th Annual Allerton Conference on Communication, Control, and Computing (Allerton). IEEE, 2012, pp. 1806-1813.
[16A] A. Barboni, H. Rezaee, F. Boem, and T. Parisini, “Detection of covert cyber-attacks in interconnected systems: A distributed model-based approach,” IEEE Transactions on Automatic Control, vol. 65, no. 9, pp. 3728-3741, 2020
[17A] V. Renganathan and Q. Ahmed, “Vulnerability analysis of highly automated vehicular systems using structural redundancy,” in Accepted for 2023 IEEE Intelligent Vehicles Symposium Workshops (IV Workshops), 2023.
[18A] J. Kim, C. Lee, H. Shim, Y. Eun, and J. H. Seo, “Detection of sensor attack and resilient state estimation for uniformly observable nonlinear systems having redundant sensors,” IEEE Transactions on Automatic Control, vol. 64, no. 3, pp. 1162-1169, 2018.
[19A] H. Shim, “A passivity-based nonlinear observer and a semi-global separation principle,” Ph.D. dissertation, Seoul National University, 2000.
[20A] M. Zhang, P. Parsch, H. Hoffmann, and A. Masrur, “Analyzing can's timing under periodically authenticated encryption,” in 2022 Design, Automation & Test in Europe Conference & Exhibition (DATE). IEEE, 2022, pp. 620-623.
[21A] M. Krysander, J. Aslund, and M. Nyberg, “An efficient algorithm for finding minimal overconstrained subsystems for model-based diagnosis,” IEEE Transactions on Systems, Man, and Cybernetics-Part A: Systems and Humans, vol. 38, no. 1, pp. 197-206, 2007.
[22A] D. Lehmer, “On euler's totient function,” Bulletin of the American Mathematical Society, vol. 38, no. 10, pp. 745-751, 1932.
[23A] M. Nyberg and E. Frisk, “Residual generation for fault diagnosis of systems described by linear differential-algebraic equations,” IEEE Transactions on Automatic Control, vol. 51, no. 12, pp. 1995-2000, 2006.
[24A] E. Frisk, “Residual generation for fault diagnosis,” Ph.D. dissertation, Linköpings universitet, 2001.
[25A] M. Krysander and E. Frisk, “Sensor placement for fault diagnosis,” IEEE Transactions on Systems, Man, and Cybernetics-Part A: Systems and Humans, vol. 38, no. 6, pp. 1398-1410, 2008.
[26A] S. Kamat, “Model predictive control approaches for lane keeping of vehicle,” IFAC-PapersOnLine, vol. 53, no. 1, pp. 176-182, 2020.
[27A] R. Marino, S. Scalzi, G. Orlando, and M. Netto, “A nested pid steering control for lane keeping in vision based autonomous vehicles,” in 2009 American Control Conference. IEEE, 2009, pp. 2885-2890.
[28A] X. Li, X.-P. Zhao, and J. Chen, “Controller design for electric power steering system using ts fuzzy model approach,” International Journal of Automation and Computing, vol. 6, no. 2, pp. 198-203, 2009.
[29A] MathWorks, “Vehicle body 3dof—3dof rigid vehicle body to calculate longitudinal, lateral, and yaw motion,” 2022 [Online]. Available: https://www.mathworks.com/help/vdynblks/ref/vehiclebody3dof.html #d124e115334
[30A] C. Becker, L. Yount, S. Rozen-Levy, J. Brewer et al., “Functional safety assessment of an automated lane centering system,” United States. Department of Transportation. National Highway Traffic Safety . . . , Tech. Rep., 2018.
[31A] Commaai, “Opendbc.” [Online]. Available: https://github.com/commaai/opendbc
[32A] T. Sato, J. Shen, N. Wang, Y. Jia, X. Lin, and Q. A. Chen, “Dirty road can attack: Security of deep learning based automated lane centering under {Physical-World} attack,” in 30th USENIX Security Symposium (USENIX Security 21), 2021.
[33A]“Highway lane following with roadrunner scenario.” [Online]. Available: https://www.mathworks.com/help/driving/ug/highway-lane-following-with-roadrunner-scenario.html
[34A] E. Frisk, M. Krysander, and D. Jung, “A toolbox for analysis and design of model based diagnosis systems for large scale models,” IFAC-PapersOnLine, vol. 50, no. 1, pp. 3287-3293, 2017, 20th IFAC World Congress. [Online]. Available: https://www.sciencedirect.com/science/article/pii/S2405896317308728
[35A] P. Mell, K. Scarfone, and S. Romanosky, “Common vulnerability scoring system,” IEEE Security & Privacy, vol. 4, no. 6, pp. 85-89, 2006.
[36A] X. Chen and S. Sankaranarayanan, “Decomposed reachability analysis for nonlinear systems,” in 2016 IEEE Real-Time Systems Symposium (RTSS). IEEE, 2016, pp. 13-24.
[37A] J. Maidens and M. Arcak, “Reachability analysis of nonlinear systems using matrix measures,” IEEE Transactions on Automatic Control, vol. 60, no. 1, pp. 265-270, 2014.
[1B] A. Greenberg, “Hackers remotely kill a jeep on the highway—with me in it,” Wired, vol. 7, no. 2, pp. 21-22, 2015.
[2B] S. Checkoway, D. McCoy, B. Kantor, D. Anderson, H. Shacham, S. Savage, K. Koscher, A. Czeskis, F. Roesner, and T. Kohno, “Comprehensive experimental analyses of automotive attack surfaces,” in 20th USENIX security symposium (USENIX Security 11), 2011.
[3B] V. Renganathan, E. Yurtsever, Q. Ahmed, and A. Yener, “Valet attack on privacy: a cybersecurity threat in automotive bluetooth infotainment systems,” Cybersecurity, vol. 5, no. 1, pp. 1-16, 2022.
[4B] C. Schmittner, Z. Ma, C. Reyes, O. Dillinger, and P. Puschner, “Using sae j3061 for automotive security requirement engineering,” in International Conference on Computer Safety, Reliability, and Security. Springer, 2016, pp. 157-170.
[5B] G. Macher, C. Schmittner, O. Veledar, and E. Brenner, “Iso/sae dis 21434 automotive cybersecurity standard—in a nutshell,” in International Conference on Computer Safety, Reliability, and Security. Springer, 2020, pp. 123-135.
[6B] C. Schmittner, “Automotive cybersecurity auditing and assessmentpresenting the iso pas 5112,” in European Conference on Software Process Improvement. Springer, 2022, pp. 521-529.
[7B] O. Henniger, A. Ruddle, H. Seudié, B. Weyl, M. Wolf, and T. Wollinger, “Securing vehicular on-board it systems: The evita project,” in VDI/VW Automotive Security Conference, 2009, p. 41.
[8B] G. Macher, H. Sporer, R. Berlach, E. Armengaud, and C. Kreiner, “Sahara: a security-aware hazard and risk analysis method,” in 2015 Design, Automation & Test in Europe Conference & Exhibition (DATE). IEEE, 2015, pp. 621-624.
[9B] P. Sharma Oruganti, P. Naghizadeh, and Q. Ahmed, “The impact of network design interventions on cps security,” in 2021 60th IEEE Conference on Decision and Control (CDC), 2021, pp. 3486-3492.
[10B] A. Khazraei, S. Hallyburton, Q. Gao, Y. Wang, and M. Pajic “Learning-based vulnerability analysis of cyber-physical systems,” in 2022 ACM/IEEE 13th International Conference on Cyber-Physical Systems (ICCPS). IEEE, 2022, pp. 259-269.
[11B] M. Blanke, M. Staroswiecki, and N. Wu, “Concepts and methods in fault-tolerant control,” in Proceedings of the 2001 American Control Conference. (Cat. No. 01CH37148), vol. 4, 2001, pp. 2606-2620 vol. 4.
[12B] D. Düştegör, E. Frisk, V. Cocquempot, M. Krysander, and M. Staroswiecki, “Structural analysis of fault isolability in the damadics benchmark,” Control Engineering Practice, 2006.
[13B] J. Kim, C. Lee, H. Shim, Y. Eun, and J. H. Seo, “Detection of sensor attack and resilient state estimation for uniformly observable nonlinear systems having redundant sensors,” IEEE Transactions on Automatic Control, vol. 64, no. 3, pp. 1162-1169, 2018.
[14B] H. Shim, “A passivity-based nonlinear observer and a semi-global separation principle,” Ph.D. dissertation, Seoul National University, 2000.
[15B] A. L. Dulmage and N. S. Mendelsohn, “Coverings of bipartite graphs,” Canadian Journal of Mathematics, vol. 10, pp. 517-534, 1958.
[16B] M. Krysander, J. Aslund, and M. Nyberg, “An efficient algorithm for finding minimal overconstrained subsystems for model-based diagnosis,” IEEE Transactions on Systems, Man, and Cybernetics-Part A: Systems and Humans, vol. 38, no. 1, pp. 197-206, 2007.
[17B] D. Lehmer, “On euler's totient function,” Bulletin of the American Mathematical Society, vol. 38, no. 10, pp. 745-751, 1932.
[18B] M. Nyberg and E. Frisk, “Residual generation for fault diagnosis of systems described by linear differential-algebraic equations,” IEEE Transactions on Automatic Control, vol. 51, no. 12, pp. 1995-2000, 2006.
[19B] M. Nyberg, “Criterions for detectability and strong detectability of faults in linear systems,” IFAC Proceedings Volumes, vol. 33, no. 11, pp. 617622, 2000.
[20B] S. Sundaram, “Fault-tolerant and secure control systems,” University of Waterloo, Lecture Notes, 2012.
[21B] S. Gracy, J. Milošević, and H. Sandberg, “Actuator security index for structured systems,” in 2020 American Control Conference (ACC). IEEE, 2020, pp. 2993-2998.
[22B] J. Van der Woude, “The generic dimension of a minimal realization of an ar system,” Mathematics of Control, Signals and Systems, vol. 8, no. 1, pp. 50-64, 1995.
[23B] X. Li, X.-P. Zhao, and J. Chen, “Controller design for electric power steering system using ts fuzzy model approach,” International Journal of Automation and Computing, vol. 6, no. 2, pp. 198-203, 2009.
[24B] S. Kamat, “Model predictive control approaches for lane keeping of vehicle,” IFAC-PapersOnLine, vol. 53, no. 1, pp. 176-182, 2020.
[25B] R. Marino, S. Scalzi, G. Orlando, and M. Netto, “A nested pid steering control for lane keeping in vision based autonomous vehicles,” in 2009 American Control Conference. IEEE, 2009, pp. 2885-2890.
[26B] C. Becker, L. Yount, S. Rozen-Levy, J. Brewer et al., “Functional safety assessment of an automated lane centering system,” United States. Department of Transportation. National Highway Traffic Safety . . . , Tech. Rep., 2018.
[27B] Commaai, “Opendbc.” [Online]. Available: https://github.com/commaai/opendbc
[28B] T. Sato, J. Shen, N. Wang, Y. Jia, X. Lin, and Q. A. Chen, “Dirty road can attack: Security of deep learning based automated lane centering under {Physical-World} attack,” in 30th USENIX Security Symposium (USENIX Security 21), 2021.

1. A method for performing vulnerability analysis, the method comprising:
providing a system model of a vehicular control system;
determining a plurality of attack vectors based on the system model;
generating an attacker model based on the plurality of attack vectors;
determining a number of vulnerabilities in the vehicular control system based on at least the attacker model and the system model;
outputting an attackability index based on the number of vulnerabilities.

2. The method of claim 1, wherein the plurality of attack vectors comprise a plurality of unprotected measurements.

3. The method of claim 2, wherein at least one of the plurality of unprotected measurements is associated with a sensor.

4. The method of claim 2, wherein at least one of the plurality of unprotected measurements is associated with an actuator.

5. The method of claim 2, further comprising recommending a design criteria to protect a measurement from the plurality of unprotected measurements based on the attackability index.

6. The method of claim 5, wherein the design criteria comprises a location in the vehicular control system to place a redundant sensor, a redundant actuator, a protected sensor, or a protected actuator.

7. The method of claim 1, wherein the vehicular control system comprises a Lane Keep Assist System.

8. The method of claim 1, wherein the vehicular control system comprises an actuator or a communication network.

9. (canceled)

10. The method of claim 1, further comprising evaluating the attackability index using a model-in-loop simulation.

11. A method of reducing an attackability index of a vehicular control system, the method comprising:
providing a system model of the vehicular control system, wherein the system model comprises a plurality of sensors;
determining a plurality of attack vectors based on the system model;
generating an attacker model based on the plurality of attack vectors;
determining a number of vulnerabilities in the vehicular control system based on at least the attacker model and the system model;
outputting an attackability index based on the number of vulnerabilities; and
selecting a sensor from the plurality of sensors to protect to minimize the attackability index.

12. The method of claim 11, wherein the vehicular control system comprises a Lane Keep Assist System.

13. The method of claim 11, wherein the vehicular control system comprises an actuator.

14. The method of claim 11, wherein the vehicular control system further comprises a communication network.

15. The method of claim 11, further comprising generating a residual based on the system model.

16. The method of claim 11, further comprising determining where in the system model to place a redundant sensor.

17. The method of claim 11, further comprising identifying a subset of redundant sensors in the plurality of sensors.

18. The method of claim 11, further comprising evaluating the attackability index using a model-in-loop simulation of the system model and the attacker model.

19. The method of claim 11, further comprising identifying a redundant section of the system model and a non-redundant section of the system model.

20. The method of claim 19, further comprising mapping the plurality of attack vectors to the redundant section of the system model and the non-redundant section of the system model.

21. The method of claim 2, further comprising providing, based on the attackability index, the vehicular control system, wherein a measurement from the plurality of unprotected measurements is protected in the vehicular control system.
